(19) United States
(12) Patent Application Publication
(10) Pub. No.: US 2011/0269628 A1
(43) Pub. Date: Nov. 3, 2011

(54) Pesticidal Mixtures

(75) Inventors: Markus Gewehr, Kastellaun (DE); Robert John Gladwin, Macclesfield (GB); Lutz Brahm, Worms (DE); Egon Haden, Ludwigshafen (DE); Marco-Antonio Tavares-Rodrigues, Sao Paulo (BR); Scott Peoples, Raleigh, NC (US)

(73) Assignee: BASF SE, Ludwigshafen (DE)

(21) Appl. No.: 13/143,247

(22) PCT Filed: Jan. 6, 2010
(86) PCT No.: PCT/EP10/50068

§ 371 Date: Jul. 5, 2011

Related U.S. Application Data
(60) Provisional application No. 61/143,049, filed on Jan. 7, 2009.
(60) Provisional application No. 61/220,217, filed on Jun. 25, 2009.

(51) Int. Cl. A01N 43/50; A01P 3/00; A01P 13/00; A01N 43/40

(52) U.S. Cl. 504/130; 504/277; 504/253; 504/247; 504/139

(57) ABSTRACT

The present invention relates to synergistic mixtures comprising, as active ingredients 1) an imidazolinone herbicide as compound (I) selected from the group consisting of imazamethabenz-methyl, imazamox, imazapic, imazapyr, imazaquin and imazethapyr; and 2) a fungicidal compound (II) of the formula (1) in which X is —C(═NOCH₃)—CONHCH₃, —C(═NOCH₃)—COOCH₃, —C(═CHOCH₃)—COOCH₃, —N(OCH₃)—COOCH₃ or —C(═NOCH₃)—R, where R is 4H-[1,5,2]dioxazin-3-yl; Y is —O—, —OCH₂—, —C(CH₃)═NOCH₂— or —CH═CH—C(CH₃)═NOCH₂—; Z is an aromatic ring system being unsubstituted or substituted, selected from phenyl, 2-methylphenyl, 3-trifluoromethylphenyl, 2,5-dimethylphenyl, 4-chlorophenyl, 2,6-dichlorophenyl, 4-chlorphenyl-1H-pyrazol-3-yl, 6-(2-cyanophenoxy)pyrimidin-4-yl, 6-(2-chlorophenoxy)-5-fluoro-pyrimidin-4-yl, 6-trifluoromethyl-pyridin-2-yl, 3-butyl-4-methyl-2-oxo-2H-chromen-7-yl and 3,4-dimethyl-2-oxo-2H-chromen-7-yl; in synergistically effective amounts. Within the scope of the invention, the health of a plant and/or the herbicidal activity and/or the fungicidal activity may be increased synergistically. In addition, the present invention relates to methods for improving the health of plants, for controlling undesirable vegetation in crops and for controlling phytopathogenic fungi in crops, wherein the plant, the locus where the plant is growing or is expected to grow or plant propagation material from which the plant grows is treated with an effective amount of a mixture as defined above.

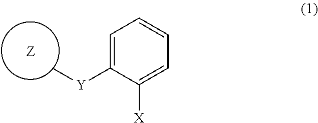

The present invention relates to synergistic mixtures comprising, as active ingredients
1) an imidazolinone herbicide as compound (I) selected from the group consisting of imazamethabenz-methyl, imazamox, imazapic, imazapyr, imazaquin and imazethapyr; and
2) a fungicidal compound (II) of the formula 1

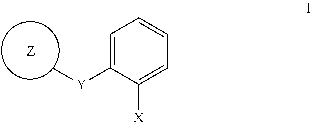

in which
X is —C(═NOCH₃)—CONHCH₃, —C(═NOCH₃)—COOCH₃, —C(═CHOCH₃)—COOCH₃, —N(OCH₃)—COOCH₃ or —C(═NOCH₃)—R, where
   R is 4H-[1,5,2]dioxazin-3-yl;
Y is —O—, —OCH₂—, —C(CH₃)═NOCH₂— or —CH═CH—C(CH₃)═NOCH₂—;
Z is an aromatic ring system being unsubstituted or substituted, selected from phenyl, 2-methylphenyl, 3-trifluoromethylphenyl, 2,5-dimethylphenyl, 4-chlorophenyl, 2,6-dichlorophenyl, 4-chlorphenyl-1H-pyrazol-3-yl, 6-(2-cyanophenoxy)pyrimidin-4-yl, 6-(2-chlorophenoxy)-5-fluoro-pyrimidin-4-yl, 6-trifluoromethyl-pyridin-2-yl, 3-butyl-4-methyl-2-oxo-2H-chromen-7-yl and 3,4-dimethyl-2-oxo-2H-chromen-7-yl;
   in synergistically effective amounts.

In a preferred embodiment, the present invention relates to synergistic mixtures comprising, as active ingredients
1) an imidazolinone herbicide as compound (I) selected from the group consisting of imazamethabenz-methyl, imazamox, imazapic, imazapyr, imazaquin and imazethapyr; and
2) a strobilurine fungicide as compound (II) selected from the group consisting of azoxystrobin, coumoxystrobin, coumethoxystrobin, dimoxystrobin, enestroburin, fluoxastrobin, kresoxim-methyl, metominostrobin, picoxystrobin, pyraclostrobin, pyrametostrobin, pyraoxystrobin, trifloxystrobin, 2-(2-(3-(2,6-di-chlorophenyl)-1-methyl-allylidene-aminooxy-methyl)-phenyl)-2-methoxyimino-N-methyl-acetamide and 2-[2-(2,5-dimethyl-phenoxymethyl)-phenyl]-3-methoxy-acrylic acid methyl ester;
   in synergistically effective amounts.

The application of these mixtures to transgenic plants which are resistant to the abovementioned herbicides is especially preferred.

Within the scope of the invention, the health of a plant and/or the herbicidal activity and/or the fungicidal activity may be increased synergistically.

The present invention relates to a method for improving the health of plants, wherein the plant, the locus where the plant is growing or is expected to grow or plant propagation material from which the plant grows is treated with an effective amount of a mixture as defined above.

The present invention especially relates to a method for increasing the yield of a plant, wherein the plant, the locus where the plant is growing or is expected to grow or plant propagation material from which the plant grows is treated with an effective amount of a mixture as defined above.

The present invention further relates to a method for improving the health of plants, in particular the yield of plants, wherein the plant, the locus where the plant is growing or is expected to grow or plant propagation material from which the plant grows is treated with an effective amount of a mixture comprising pyraclostrobin as compound (II) and imazamethabenz-methyl or imazamox or imazapic or imazapyr or imazaquin or imazethapyr as compound (I).

The present invention further relates to a method for improving the health of plants, in particular the yield of plants, wherein the plant, the locus where the plant is growing or is expected to grow or plant propagation material from which the plant grows is treated with an effective amount of a mixture comprising imazamox, imazethapyr, imazapic or imazapyr as compound (I) and pyraclostrobin as compound (II).

The present invention additionally relates to the use of a mixture comprising an imidazolinone herbicide as compound (I) and a fungicidal compound (II) as defined above for synergistically increasing the health of a plant.

The present invention further relates to a method for controlling undesirable vegetation in crops, wherein the plant, the locus where the plant is growing or is expected to grow or plant propagation material from which the plant grows is treated with an effective amount of a mixture as defined above.

The present invention additionally relates to the use of a mixture comprising an imidazolinone herbicide as compound (I) and a fungicidal compound (II) as defined above for synergistically controlling undesirable vegetation in crops.

The present invention further relates to a method for controlling phytopathogenic fungi in crops, wherein the plant, the locus where the plant is growing or is expected to grow or plant propagation material from which the plant grows is treated with an effective amount of a mixture as defined above.

The present invention additionally relates to the use of a mixture comprising an imidazolinone herbicide as compound (I) and a fungicidal compound (II) for synergistically controlling phytopathogenic fungi in crops.

The compounds (I) and (II) as well as their pesticidal action and methods for producing them are generally known. For instance, the commercially available compounds may be found in The Pesticide Manual, 14th Edition, British Crop Protection Council (2006) among other publications.

Referring to imidazolinone herbicides (compound I) or specific imidazolinone herbicide species in this application shall mean the compounds as mentioned above, as well as their a) salts, e.g. salts of alkaline or earth alkaline metals or ammonium or organoammonium salts, for instance, sodium, potasium, ammonium, preferably isopropyl ammonium etc.; b) respective isomers, e.g. stereo isomers such as the respective enantiomers, in particular the respective R- or S-enantiomers (including salts, ester, amides), c) respective esters, e.g. carboxylic acid C₁-C₈-(branched or non-branched) alkyl esters, such as methyl esters, ethyl esters, isopropyl esters, d) respective amides, e.g. carboxylic acid amides or carboxylic acid C₁-C₈-(branched or non-branched) mono or di alkyl amides, such as dimethylamides, diethylamides, diisopropyl amides or e) any other derivative which contains the above imidazolinone structures as structural moiety.

The imidazolinones may be present in the form of their racemate or in the form of the pure R- or S-enantiomers (including salts and esters as defined above). Very suitable imidazolinones are the R-isomers, e.g. R-imazamethabenz-methyl, R-imazamox, R-imazapic, R-imazapyr, R-imazaquin, R-imazethapyr, in particular R-imazamox. These compounds are known e.g. from U.S. Pat. No. 5,973,154 B (American Cyanamid Company) and U.S. Pat. No. 6,339,158 B1 (American Cyanamid Company).

The mixtures and compositions of this invention can preferably be used in crops which tolerate and/or are resistant to the action of AHAS herbicides, preferably in crops which are tolerant and/or resistant to the action of imidazolinone herbicides. The resistance and or tolerance to said herbicides may be achieved by conventional breeding and/or by genetic engineering methods. Crops which are tolerant to AHAS herbicides (e.g. tolerant to imidazolinone herbicides) are known for example from EP 0154204 A (MGI Pharma Inc.). Such crops are for example marketed by BASF under the trade name CLEARFIELD®. Examples for such crops are maize, canola, oilseed rape, sunflower, rice, soybean, lentils and wheat.

US 2003/0060371 discloses a method of improving the yield and vigor of an agronomic plant by applying a composition that includes an active agent such as a diazole fungicide, a diazole fungicide or a strobilurin-type fungicide. If desirable, such compositions can also include herbicides, insecticides, nematicides, acarizicides, fungicides, and the like, growth factors, fertilizers, and any other material. The particular mixtures of the present application as well as the synergistic plant health or synergistic yield increasing effects, are not disclosed therein.

WO 2006/066810 discloses inter alia mixtures of orysastrobin and herbicides seletected imazethapyr, imazamox, imazapyr, imazapic and dimethenamid-p. The particular mixtures of the present application as well as the synergistic plant health or synergistic yield increasing effects, are not disclosed therein.

US 2006/111239 discloses mixtures of pyraclostrobin and glyphosate in modified leguminoses. Combinations of pyraclostrobin with imidazolinones are not mentioned therein.

WO 07/115,944 relates to herbicidal mixtures of an imidazolinone herbicide and an adjuvant.

WO 08/116,730 relates to novel combinations of active substances, comprising a known herbicide selected from gyphosate derivatives, cyclohexenone-oximene, imidazolinone derivatives, dinitroaniline derivates, amide derivatives and quaternary ammonium salts, and at least one fungicidal active substance, said combinations being suitable for combating undesired phytopathogenic fungi.

It is already known from the literature that compounds (II), which are generally referred to as strobilurins, are capable of bringing about increased yields in crop plants in addition to their fungicidal action (Koehle H. et al. in Gesunde Pflanzen 49 (1997), pages 267-271; Glaab J. et al. Planta 207 (1999), 442-448)).

None of these references disclose the synergistic effects of the mixtures as defined at the outset.

However, in crop protection, there is a continuous need for compositions that improve the health of plants. Healthier plants are desirable since they result among other in better yields and/or a better quality of the plants or crops. Healthier plants also better resist to biotic and/or abiotic stress. A high resistance against biotic stresses in turn allows the person skilled in the art to reduce the quantity of pesticides applied and consequently to slow down the development of resistances against the respective pesticides.

It was therefore an object of the present invention to provide a pesticidal composition which solves the problems outlined above, and which should, in particular, improve plant health, in particular the yield of plants.

Another problem encountered concerns the need to have available pest control agents which are effective against a broad spectrum of pests (including undesirable vegetation) and pathogens such as phytopathogenic fungi. The combating of harmful phytopathogenic fungi is, however, not the only problem the farmer has to face. Also undesirable plants can cause great damage to crops which may result in a strong decrease in yield. An efficient combination of fungicidal and herbicidal activity is desirable to overcome these problems. Thus, it is a further object of the present invention to provide a mixture that, on the one hand, has good fungicidal activity, and, on the other hand, good herbicidal activity, resulting in a broader pesticidal spectrum of action.

We have found that these objects are in part or in whole achieved by the mixtures comprising the active ingredients as defined in the outset. We have found that simultaneous, that is joint or separate, application of the compound (I) and the compound (II) or successive application of compound (I) and the compound (II) provides enhanced plant health effects compared to the plant health effects that are possible with the individual compounds, in particular enhanced yield effects compared to the yield effects that are possible with the individual compounds (synergistic effect). In addition we have found that the simultaneous, that is joint or separate application of the compound (I) and the compound (II) or successive application of compound (I) and the compound (II) provides enhanced control of undesirable vegetation compared to the control of undesirable vegetation which is possible with the individual compounds (synergistic effect). We have also found that that the simultaneous, that is joint or separate application of the compound (I) and the compound (II) or successive application of compound (I) and the compound (II) provides enhanced control of phytopathogenic fungi compared to the control of phytopathogenic fungi which is possible with the individual compounds (synergistic effect).

In a preferred embodiment of the invention, the mixture comprises a herbicidal compound (I) selected from the group consisting of imazamox, imazethapyr, imazapic and imazapyr. In an even more preferred embodiment of the invention, the mixture comprises imazethapyr or imazamox as compound (I). In an especially preferred embodiment, the mixture comprises imazamox as compound (I).

In a preferred embodiment of the invention, the mixture comprises a fungicidal compound (II) selected from the group consisting of azoxystrobin, trifloxystrobin, picoxystrobin and pyraclostrobin. In an even more preferred embodiment of the invention, the mixture comprises azoxystrobin, trifloxystrobin or pyraclostrobin as compound (II).

In an especially preferred embodiment, the mixture comprises pyraclostrobin as compound (II).

With respect to their intended use in the methods of the present invention, the following binary mixtures listed in table 1 comprising one compound (I) and one compound (II) are a preferred embodiment of the present invention.

Within table 1, the following abbreviations are used: (I) is compound (I); (II) is compound (II); P=pyraclostrobin; PY=pyrametostrobin; PR=pyraoxystrobin T=trifloxystrobin; A=azoxystrobin; E=enestroburin; F=fluoxastrobin; K=kresoxim-methyl, M=metominostrobin; PI=picoxystrobin; C=coumoxystrobin; CE=coumethoxystrobin; D=dimoxystrobin; S-1=2-(2-(3-(2,6-di-chlorophenyl)-1-methyl-allylidene-aminooxy-methyl)-phenyl)-2-methoxyimino-N-methyl-acetamide, S-2=2-[2-(2,5-dimethyl-phenoxymethyl)-phenyl]-3-methoxy-acrylic acid methyl ester,

TABLE 1

| No. | (II) | (I) |
|---|---|---|
| M-1 | P | imazethapyr |
| M-2 | P | imazamox |
| M-3 | P | imazapyr |
| M-4 | P | imazapic |
| M-5 | P | imazamethabenz-methyl |
| M-6 | P | imazaquin |
| M-7 | A | imazethapyr |
| M-8 | A | imazamox |
| M-9 | A | imazapyr |
| M-10 | A | imazapic |
| M-11 | A | imazamethabenz-methyl |
| M-12 | A | imazaquin |
| M-13 | T | imazethapyr |
| M-14 | T | imazamox |
| M-15 | T | imazapyr |
| M-16 | T | imazapic |
| M-17 | T | imazamethabenz-methyl |
| M-18 | T | imazaquin |
| M-19 | PI | imazethapyr |
| M-20 | PI | imazamox |
| M-21 | PI | imazapyr |
| M-22 | PI | imazapic |
| M-23 | PI | imazamethabenz-methyl |
| M-24 | PI | imazaquin |
| M-25 | PI | imazethapyr |
| M-26 | F | imazamox |
| M-27 | F | imazapyr |
| M-28 | F | imazapic |
| M-29 | F | imazamethabenz-methyl |
| M-30 | F | imazaquin |
| M-31 | K | imazethapyr |
| M-32 | K | imazamox |
| M-33 | K | imazapyr |
| M-34 | K | imazapic |
| M-35 | K | imazamethabenz-methyl |
| M-36 | K | imazaquin |
| M-37 | PY | imazethapyr |
| M-38 | PY | imazamox |
| M-39 | PY | imazapyr |
| M-40 | PY | imazapic |
| M-41 | PY | imazamethabenz-methyl |
| M-42 | PY | imazaquin |
| M-43 | M | imazethapyr |
| M-44 | M | imazamox |
| M-45 | M | imazapyr |
| M-46 | M | imazapic |
| M-47 | M | imazamethabenz-methyl |
| M-48 | M | imazaquin |
| M-49 | E | imazethapyr |
| M-50 | E | imazamox |
| M-51 | E | imazapyr |
| M-52 | E | imazapic |
| M-53 | E | imazamethabenz-methyl |
| M-54 | E | imazaquin |
| M-55 | S-1 | imazethapyr |
| M-56 | S-1 | imazamox |
| M-57 | S-1 | imazapyr |
| M-58 | S-1 | imazapic |
| M-59 | S-1 | imazamethabenz-methyl |
| M-60 | S-1 | imazaquin |
| M-61 | S-2 | imazethapyr |
| M-62 | S-2 | imazamox |
| M-63 | S-2 | imazapyr |
| M-64 | S-2 | imazapic |
| M-65 | S-2 | imazamethabenz-methyl |
| M-66 | S-2 | imazaquin |
| M-67 | PR | imazethapyr |
| M-68 | PR | imazamox |
| M-69 | PR | imazapyr |
| M-70 | PR | imazapic |
| M-71 | PR | imazamethabenz-methyl |
| M-72 | PR | imazaquin |
| M-73 | C | imazethapyr |
| M-74 | C | imazamox |
| M-75 | C | imazapyr |
| M-76 | C | imazapic |
| M-77 | C | imazamethabenz-methyl |
| M-78 | C | imazaquin |
| M-79 | D | imazethapyr |
| M-80 | D | imazamox |
| M-81 | D | imazapyr |
| M-82 | D | imazapic |
| M-83 | D | imazamethabenz-methyl |
| M-84 | D | imazaquin |
| M-85 | CE | imazethapyr |
| M-86 | CE | imazamox |
| M-87 | CE | imazapyr |
| M-88 | CE | imazapic |
| M-89 | CE | imazamethabenz-methyl |
| M-90 | CE | imazaquin |

The present invention comprises the binary mixtures M-1, M-2, M-3, M-4, M-5, M-6, M-7, M-8, M-9, M-10, M-11, M-12, M-13, M-14, M-15, M-16, M-17, M-18, M-19, M-20, M-21, M-22, M-23, M-24, M-25, M-26, M-27, M-28, M-29, M-30, M-31, M-32, M-33, M-34, M-35, M-36, M-37, M-38, M-39, M-40, M-41, M-42, M-43, M-44, M-45, M-46, M-47, M-48, M-49, M-50, M-51, M-52, M-53, M-54, M-55, M-56, M-57, M-58, M-59, M-60, M-61, M-62, M-63, M-64, M-65, M-66, M-67, M-68, M-69, M-70, M-71, M-72 M-79, M-80, M-81, M-82, M-83, M-84, M-85, M-86, M-87, M-88, M-89 and M-90.

The mixtures M-1, M-2, M-3, M-4, M-5, M-6, M-7, M-8, M-9, M-10, M-11, M-12, M-13, M-14, M-15, M-16, M-17, M-18, M-19, M-20, M-21, M-22, M-23, M-24, M-25, M-31, M-32, M-33, M-34, M-35, M-36, M-49, M-50, M-51, M-52, M-53 and M-54 are preferred, the mixtures M-1, M-2, M-3, M-4, M-5, M-6, M-7, M-8, M-9, M-10, M-11, M-12, M-13, M-14, M-15, M-16, M-17 and M-18 are more preferred and the mixtures M-1, M-2, M-3, M-4, M-7, M-8, M-9, M-10, M-13, M-14, M15 and M-16 are most preferred; and the mixtures M-1, M-2, M-3 and M-4 are utmost preferred.

In the methods of the invention, in particular when used for increasing the health of plants, in particular increasing the yield of plants, the following mixtures are used, wherein the following mixtures M-1, M-2, M-3, M-4, M-5, M-6, M-7, M-8, M-9, M-10, M-11, M-12, M-13, M-14, M-15, M-16, M-17, M-18, M-19, M-20, M-21, M-22, M-23, M-24, M-25, M-31, M-32, M-33, M-34, M-35, M-36, M-49, M-50, M-51, M-52, M-53 and M-54 are preferred; the mixtures M-1, M-2, M-3, M-4, M-5, M-6, M-7, M-8, M-9, M-10, M-11, M-12, M-13, M-14, M-15, M-16, M-17 and M-18 more preferred; the mixtures M-1, M-2, M-3, M-4, M-7, M-8, M-9, M-10, M-13, M-14, M15 and M-16 are most preferred and the mixtures M-1, M-2, M-3 and M-4 are utmost preferred.

In an especially preferred embodiment, the binary mixture used for synergistically improving the health of plants comprises imazethapyr as compound (I) and pyraclostrobin as compound (II). In another especially preferred embodiment, this binary mixture is used for synergistically controlling undesirable vegetation in crops. In yet another especially preferred embodiment, this binary mixture is used for synergistically controlling phytopathogenic fungi in crops.

In an especially preferred embodiment, the binary mixture used for synergistically improving the health of plants comprises imazamox as compound (I) and pyraclostrobin as compound (II). In another especially preferred embodiment, this binary mixture is used for synergistically controlling undesirable vegetation in crops. In yet another especially preferred embodiment, this binary mixture is used for synergistically controlling phytopathogenic fungi in crops.

In an especially preferred embodiment, the binary mixture used for synergistically improving the health of plants comprises imazapyr as compound (I) and pyraclostrobin as compound (II). In another especially preferred embodiment, this binary mixture is used for synergistically controlling undesirable vegetation in crops. In yet another especially preferred embodiment, this binary mixture is used for synergistically controlling phytopathogenic fungi in crops.

In an especially preferred embodiment, the binary mixture used for synergistically improving the health of plants comprises imazapic as compound (I) and pyraclostrobin as compound (II). In another especially preferred embodiment, this binary mixture is used for synergistically controlling undesirable vegetation in crops. In yet another especially preferred embodiment, this binary mixture is used for synergistically controlling phytopathogenic fungi in crops.

All embodiments of the mixtures set forth above (including the respective preferences as set forth above and also the combinations with pyraclostrobin) are hereinbelow referred to as “inventive mixture”.

The inventive mixtures can further contain one or more insecticides, fungicides, herbicides and plant growth regulators.

In one embodiment, a mixture as described above, additionally comprises a second imidazolinone herbicide as compound (III) selected from the group consisting of imazamethabenz-methyl, imazamox, imazapic, imazapyr, imazaquin and imazethapyr.

In another embodiment, ternary mixtures are used comprising:
1) an imidazolinone herbicide as compound (I) selected from the group consisting of imazamox (I-1), imazethapyr (I-2), imazapic (I-3), imazapyr (I-4), imazamethabenz-methyl (I-5) and imazaquin (I-6); and
2) a strobilurine fungicide as compound (II) selected from the group consisting of pyraclostrobin (P), pyrametostrobin (PY), pyraoxystrobin (PR), trifloxystrobin (T), azoxystrobin (A), enestroburin (E), fluoxastrobin (F), kresoxim-methyl (K), metominostrobin (M), picoxystrobin (PI), coumoxystrobin (C), coumethoxystrobin (CE), dimoxystrobin (D), 2-(2-(3-(2,6-di-chlorophenyl)-1-methyl-allylidene-aminooxy-methyl)-phenyl)-2-methoxyimino-N-methyl-acetamide (S-1) and 2-[2-(2,5-dimethyl-phenoxymethyl)-phenyl]-3-methoxy-acrylic acid methyl ester (S-2);
3) and, as a third active ingredient, a second imidazolinone herbicide selected from the group consisting of imazamox (I-1), imazethapyr (I-2), imazapic (I-3), imazapyr (I-4), imazamethabenz-methyl (I-5) and imazaquin (I-6) as compound (III).

With respect to their intended use in the methods of the present invention, the following ternary mixtures listed in table 2 comprising one compound (I) and one compound (II) and one compound (III) are a preferred embodiment of the present invention.

TABLE 2

| | (I) | (II) | (III) |
|---|---|---|---|
| T-1 | I-1 | P | I-1 |
| T-2 | I-1 | P | I-2 |
| T-3 | I-1 | P | I-3 |
| T-4 | I-1 | P | I-4 |
| T-5 | I-1 | P | I-5 |
| T-6 | I-1 | P | I-6 |
| T-7 | I-1 | PY | I-1 |
| T-8 | I-1 | PY | I-2 |
| T-9 | I-1 | PY | I-3 |
| T-10 | I-1 | PY | I-4 |
| T-12 | I-1 | PY | I-6 |
| T-11 | I-1 | PY | I-5 |
| T-13 | I-1 | PR | I-1 |
| T-14 | I-1 | PR | I-2 |
| T-15 | I-1 | PR | I-3 |
| T-16 | I-1 | PR | I-4 |
| T-17 | I-1 | PR | I-5 |
| T-18 | I-1 | PR | I-6 |
| T-19 | I-1 | T | I-1 |
| T-20 | I-1 | T | I-2 |
| T-21 | I-1 | T | I-3 |
| T-22 | I-1 | T | I-4 |
| T-23 | I-1 | T | I-5 |
| T-24 | I-1 | T | I-6 |
| T-25 | I-1 | A | I-1 |
| T-26 | I-1 | A | I-2 |
| T-27 | I-1 | A | I-3 |
| T-28 | I-1 | A | I-4 |
| T-29 | I-1 | A | I-5 |
| T-30 | I-1 | A | I-6 |
| T-31 | I-1 | E | I-1 |
| T-32 | I-1 | E | I-2 |
| T-33 | I-1 | E | I-3 |
| T-34 | I-1 | E | I-4 |
| T-35 | I-1 | E | I-5 |
| T-36 | I-1 | E | I-6 |
| T-37 | I-1 | F | I-1 |
| T-38 | I-1 | F | I-2 |
| T-39 | I-1 | F | I-3 |
| T-40 | I-1 | F | I-4 |
| T-41 | I-1 | F | I-5 |
| T-42 | I-1 | F | I-6 |
| T-43 | I-1 | K | I-1 |
| T-44 | I-1 | K | I-2 |
| T-45 | I-1 | K | I-3 |
| T-46 | I-1 | K | I-4 |
| T-47 | I-1 | K | I-5 |
| T-48 | I-1 | K | I-6 |
| T-49 | I-1 | M | I-1 |
| T-50 | I-1 | M | I-2 |
| T-51 | I-1 | M | I-3 |
| T-52 | I-1 | M | I-4 |
| T-53 | I-1 | M | I-5 |
| T-54 | I-1 | M | I-6 |
| T-55 | I-1 | PI | I-1 |
| T-56 | I-1 | PI | I-2 |
| T-57 | I-1 | PI | I-3 |
| T-58 | I-1 | PI | I-4 |
| T-59 | I-1 | PI | I-5 |
| T-60 | I-1 | PI | I-6 |
| T-61 | I-1 | C | I-1 |
| T-62 | I-1 | C | I-2 |
| T-63 | I-1 | C | I-3 |
| T-64 | I-1 | C | I-4 |
| T-65 | I-1 | C | I-5 |
| T-66 | I-1 | C | I-6 |
| T-67 | I-1 | CE | I-1 |
| T-68 | I-1 | CE | I-2 |
| T-69 | I-1 | CE | I-3 |
| T-70 | I-1 | CE | I-4 |
| T-71 | I-1 | CE | I-5 |
| T-72 | I-1 | CE | I-6 |
| T-73 | I-1 | D | I-1 |
| T-74 | I-1 | D | I-2 |
| T-75 | I-1 | D | I-3 |
| T-76 | I-1 | D | I-4 |
| T-77 | I-1 | D | I-5 |
| T-78 | I-1 | D | I-6 |
| T-79 | I-1 | S-1 | I-1 |
| T-80 | I-1 | S-1 | I-2 |
| T-81 | I-1 | S-1 | I-3 |
| T-82 | I-1 | S-1 | I-4 |
| T-83 | I-1 | S-1 | I-5 |
| T-84 | I-1 | S-1 | I-6 |
| T-85 | I-1 | S-2 | I-1 |
| T-86 | I-1 | S-2 | I-2 |
| T-87 | I-1 | S-2 | I-3 |
| T-88 | I-1 | S-2 | I-4 |
| T-89 | I-1 | S-2 | I-5 |
| T-90 | I-1 | S-2 | I-6 |
| T-91 | I-2 | P | I-2 |
| T-92 | I-2 | P | I-3 |
| T-93 | I-2 | P | I-4 |
| T-94 | I-2 | P | I-5 |
| T-95 | I-2 | P | I-6 |
| T-96 | I-2 | PY | I-2 |
| T-97 | I-2 | PY | I-3 |
| T-98 | I-2 | PY | I-4 |
| T-99 | I-2 | PY | I-5 |
| T-100 | I-2 | PY | I-6 |
| T-101 | I-2 | PR | I-2 |
| T-102 | I-2 | PR | I-3 |
| T-103 | I-2 | PR | I-4 |
| T-104 | I-2 | PR | I-5 |
| T-105 | I-2 | PR | I-6 |
| T-106 | I-2 | T | I-2 |
| T-107 | I-2 | T | I-3 |
| T-108 | I-2 | T | I-4 |
| T-109 | I-2 | T | I-5 |
| T-110 | I-2 | T | I-6 |
| T-111 | I-2 | A | I-2 |
| T-112 | I-2 | A | I-3 |
| T-113 | I-2 | A | I-4 |
| T-114 | I-2 | A | I-5 |
| T-115 | I-2 | A | I-6 |
| T-116 | I-2 | E | I-2 |
| T-117 | I-2 | E | I-3 |
| T-118 | I-2 | E | I-4 |
| T-119 | I-2 | E | I-5 |
| T-120 | I-2 | E | I-6 |
| T-121 | I-2 | F | I-2 |
| T-122 | I-2 | F | I-3 |
| T-123 | I-2 | F | I-4 |
| T-124 | I-2 | F | I-5 |
| T-125 | I-2 | F | I-6 |
| T-126 | I-2 | K | I-2 |
| T-127 | I-2 | K | I-3 |
| T-128 | I-2 | K | I-4 |
| T-129 | I-2 | K | I-5 |
| T-130 | I-2 | K | I-6 |
| T-131 | I-2 | M | I-2 |
| T-132 | I-2 | M | I-3 |
| T-133 | I-2 | M | I-4 |
| T-134 | I-2 | M | I-5 |
| T-135 | I-2 | M | I-6 |
| T-136 | I-2 | PI | I-2 |
| T-137 | I-2 | PI | I-3 |
| T-138 | I-2 | PI | I-4 |
| T-139 | I-2 | PI | I-5 |
| T-140 | I-2 | PI | I-6 |
| T-141 | I-2 | C | I-2 |
| T-142 | I-2 | C | I-3 |
| T-143 | I-2 | C | I-4 |
| T-144 | I-2 | C | I-5 |
| T-145 | I-2 | C | I-6 |
| T-146 | I-2 | CE | I-2 |
| T-147 | I-2 | CE | I-3 |
| T-148 | I-2 | CE | I-4 |
| T-149 | I-2 | CE | I-5 |
| T-150 | I-2 | CE | I-6 |
| T-151 | I-2 | D | I-2 |
| T-152 | I-2 | D | I-3 |
| T-153 | I-2 | D | I-4 |
| T-154 | I-2 | D | I-5 |
| T-155 | I-2 | D | I-6 |
| T-156 | I-2 | S-1 | I-2 |
| T-157 | I-2 | S-1 | I-3 |
| T-158 | I-2 | S-1 | I-4 |
| T-159 | I-2 | S-1 | I-5 |
| T-160 | I-2 | S-1 | I-6 |
| T-161 | I-2 | S-2 | I-2 |
| T-162 | I-2 | S-2 | I-3 |
| T-163 | I-2 | S-2 | I-4 |
| T-164 | I-2 | S-2 | I-5 |
| T-165 | I-2 | S-2 | I-6 |
| T-166 | I-3 | P | I-3 |
| T-167 | I-3 | P | I-4 |
| T-168 | I-3 | P | I-5 |
| T-169 | I-3 | P | I-6 |
| T-170 | I-3 | PY | I-3 |
| T-171 | I-3 | PY | I-4 |
| T-172 | I-3 | PY | I-5 |
| T-173 | I-3 | PY | I-6 |
| T-174 | I-3 | PR | I-3 |
| T-175 | I-3 | PR | I-4 |
| T-176 | I-3 | PR | I-5 |
| T-177 | I-3 | PR | I-6 |
| T-178 | I-3 | T | I-3 |
| T-179 | I-3 | T | I-4 |
| T-180 | I-3 | T | I-5 |
| T-181 | I-3 | T | I-6 |
| T-182 | I-3 | A | I-3 |
| T-183 | I-3 | A | I-4 |
| T-184 | I-3 | A | I-5 |
| T-185 | I-3 | A | I-6 |
| T-186 | I-3 | E | I-3 |
| T-187 | I-3 | E | I-4 |
| T-188 | I-3 | E | I-5 |
| T-189 | I-3 | E | I-6 |
| T-190 | I-3 | F | I-3 |
| T-191 | I-3 | F | I-4 |
| T-192 | I-3 | F | I-5 |
| T-193 | I-3 | F | I-6 |
| T-194 | I-3 | K | I-3 |
| T-195 | I-3 | K | I-4 |
| T-196 | I-3 | K | I-5 |
| T-197 | I-3 | K | I-6 |
| T-198 | I-3 | M | I-3 |
| T-199 | I-3 | M | I-4 |
| T-200 | I-3 | M | I-5 |
| T-201 | I-3 | M | I-6 |
| T-202 | I-3 | PI | I-3 |
| T-203 | I-3 | PI | I-4 |
| T-204 | I-3 | PI | I-5 |
| T-205 | I-3 | PI | I-6 |
| T-206 | I-3 | C | I-3 |
| T-207 | I-3 | C | I-4 |
| T-208 | I-3 | C | I-5 |
| T-209 | I-3 | C | I-6 |
| T-210 | I-3 | CE | I-3 |
| T-211 | I-3 | CE | I-4 |
| T-212 | I-3 | CE | I-5 |
| T-213 | I-3 | CE | I-6 |
| T-214 | I-3 | D | I-3 |
| T-215 | I-3 | D | I-4 |
| T-216 | I-3 | D | I-5 |
| T-217 | I-3 | D | I-6 |
| T-218 | I-3 | S-1 | I-3 |
| T-219 | I-3 | S-1 | I-4 |
| T-220 | I-3 | S-1 | I-5 |
| T-221 | I-3 | S-1 | I-6 |
| T-222 | I-3 | S-2 | I-3 |
| T-223 | I-3 | S-2 | I-4 |
| T-224 | I-3 | S-2 | I-5 |
| T-225 | I-3 | S-2 | I-6 |
| T-226 | I-4 | P | I-4 |
| T-227 | I-4 | P | I-5 |
| T-228 | I-4 | P | I-6 |
| T-229 | I-4 | PY | I-4 |
| T-230 | I-4 | PY | I-5 |
| T-231 | I-4 | PY | I-6 |
| T-232 | I-4 | PR | I-4 |
| T-233 | I-4 | PR | I-5 |
| T-234 | I-4 | PR | I-6 |
| T-235 | I-4 | T | I-4 |
| T-236 | I-4 | T | I-5 |
| T-237 | I-4 | T | I-6 |
| T-238 | I-4 | A | I-4 |
| T-239 | I-4 | A | I-5 |
| T-240 | I-4 | A | I-6 |
| T-241 | I-4 | E | I-4 |
| T-242 | I-4 | E | I-5 |
| T-243 | I-4 | E | I-6 |
| T-244 | I-4 | F | I-4 |
| T-245 | I-4 | F | I-5 |
| T-246 | I-4 | F | I-6 |
| T-247 | I-4 | K | I-4 |
| T-248 | I-4 | K | I-5 |
| T-249 | I-4 | K | I-6 |
| T-250 | I-4 | M | I-4 |
| T-251 | I-4 | M | I-5 |
| T-252 | I-4 | M | I-6 |
| T-253 | I-4 | PI | I-4 |
| T-254 | I-4 | PI | I-5 |
| T-255 | I-4 | PI | I-6 |
| T-256 | I-4 | C | I-4 |
| T-257 | I-4 | C | I-5 |
| T-258 | I-4 | C | I-6 |
| T-259 | I-4 | CE | I-4 |
| T-260 | I-4 | CE | I-5 |
| T-261 | I-4 | CE | I-6 |
| T-262 | I-4 | D | I-4 |
| T-263 | I-4 | D | I-5 |
| T-264 | I-4 | D | I-6 |
| T-265 | I-4 | S-1 | I-4 |
| T-266 | I-4 | S-1 | I-5 |
| T-267 | I-4 | S-1 | I-6 |
| T-268 | I-4 | S-2 | I-4 |
| T-269 | I-4 | S-2 | I-5 |
| T-270 | I-4 | S-2 | I-6 |
| T-271 | I-5 | P | I-5 |
| T-272 | I-5 | P | I-6 |
| T-273 | I-5 | PY | I-5 |
| T-274 | I-5 | PY | I-6 |
| T-275 | I-5 | PR | I-5 |
| T-276 | I-5 | PR | I-6 |
| T-277 | I-5 | T | I-5 |
| T-278 | I-5 | T | I-6 |
| T-279 | I-5 | A | I-5 |
| T-280 | I-5 | A | I-6 |
| T-281 | I-5 | E | I-5 |
| T-282 | I-5 | E | I-6 |
| T-283 | I-5 | F | I-5 |
| T-284 | I-5 | F | I-6 |
| T-285 | I-5 | K | I-5 |
| T-286 | I-5 | K | I-6 |
| T-287 | I-5 | M | I-5 |
| T-288 | I-5 | M | I-6 |
| T-289 | I-5 | PI | I-5 |
| T-290 | I-5 | PI | I-6 |
| T-291 | I-5 | C | I-5 |
| T-292 | I-5 | C | I-6 |
| T-293 | I-5 | CE | I-5 |
| T-294 | I-5 | CE | I-6 |
| T-295 | I-5 | D | I-5 |
| T-296 | I-5 | D | I-6 |
| T-297 | I-5 | S-1 | I-5 |
| T-298 | I-5 | S-1 | I-6 |
| T-299 | I-5 | S-2 | I-5 |
| T-300 | I-5 | S-2 | I-6 |
| T-301 | I-6 | P | I-6 |
| T-302 | I-6 | PY | I-6 |
| T-303 | I-6 | PR | I-6 |
| T-304 | I-6 | T | I-6 |
| T-305 | I-6 | A | I-6 |
| T-306 | I-6 | E | I-6 |
| T-307 | I-6 | F | I-6 |
| T-308 | I-6 | K | I-6 |
| T-309 | I-6 | M | I-6 |
| T-310 | I-6 | PI | I-6 |
| T-311 | I-6 | C | I-6 |
| T-312 | I-6 | CE | I-6 |
| T-313 | I-6 | D | I-6 |
| T-314 | I-6 | S-1 | I-6 |
| T-315 | I-6 | S-2 | I-6 |

All mixtures set forth above are also an embodiment of the present invention.

Within the ternary mixtures of table 2, the following mixtures are preferred according to

the present invention: T-2, T-3, T-4, T-5, T-6, T-8, T-9, T-10, T-14, T-15, T-16, T-20, T-21, T-22, T-26, T-27, T-28, T-32, T-33, T-34, T-38, T-39, T-40, T-44, T-45, T-46, T-50, T-51, T-52, T-56, T-57, T-58, T-62, T-63, T-64, T-68, T-69, T-70, T-74, T-75, T-76, T-80, T-81, T-82, T-86, T-86, T-88, T-92, T-93, T-94, T-95, T-102, T-103, T-107, T-108, T-112, T-113, T-117, T-118, T-122, T-123, T-127, T-128, T-132, T-133, T-137, T-138, T-142, T-143, T-147, T-148, T-152, T-153, T-157, T-158, T-162, T-163, T-167, T-168, T-169, T-171, T-175, T-179, T-183, T-187, T-191, T-195, T-199, T-203, T-207, T-211, T-215, T-219, T-223, T-227, T-228 and T-272. Within this subset, the following mixtures are especially preferred: T-2, T-3, T-4, T-5, T-6, T-20, T-21, T-22, T-26, T-27, T-28, T-38, T-39, T-40, T-44, T-45, T-46, T-56, T-57, T-58, T-68, T-69, T-70, T-92, T-93, T-94, T-95, T-107, T-108, T-112, T-113, T-122, T-123, T-127, T-128, T-137, T-138, T-147, T-148, T-167, T-168, T-169, T-179, T-183, T-191, T-195, T-203, T-211, T-227, T-228 and T-272. The following mixtures are even more preferred: T-2, T-3, T-4, T-5, T-6, T-92, T-93, T-94, T-95, T-167, T-168, T-169, T-227, T-228 and T-272. Most preferred mixtures are: T-2, T-3, T-4, T-92, T-93 and T-167.

Preferred for the use within the methods according to the invention are, in particular, the following mixtures: T-2, T-3, T-4, T-5, T-6, T-8, T-9, T-10, T-14, T-15, T-16, T-20, T-21, T-22, T-26, T-27, T-28, T-32, T-33, T-34, T-38, T-39, T-40, T-44, T-45, T-46, T-50, T-51, T-52, T-56, T-57, T-58, T-62, T-63, T-64, T-68, T-69, T-70, T-74, T-75, T-76, T-80, T-81, T-82, T-86, T-86, T-88, T-92, T-93, T-94, T-95, T-102, T-103, T-107, T-108, T-112, T-113, T-117, T-118, T-122, T-123, T-127, T-128, T-132, T-133, T-137, T-138, T-142, T-143, T-147, T-148, T-152, T-153, T-157, T-158, T-162, T-163, T-167, T-168, T-169, T-171, T-175, T-179, T-183, T-187, T-191, T-195, T-199, T-203, T-207, T-211, T-215, T-219, T-223, T-227, T-228 and T-272. Especially preferred for the use within the methods according to the invention are, in particluar, the following mixtures: T-2, T-3, T-4, T-5, T-6, T-20, T-21, T-22, T-26, T-27, T-28, T-38, T-39, T-40, T-44, T-45, T-46, T-56, T-57, T-58, T-68, T-69, T-70, T-92, T-93, T-94, T-95, T-107, T-108, T-112, T-113, T-122, T-123, T-127, T-128, T-137, T-138, T-147, T-148, T-167, T-168, T-169, T-179, T-183, T-191, T-195, T-203, T-211, T-227, T-228 and T-272. Even more preferred for the use within the methods according to the invention are, in particular, the following mixtures T-2, T-3, T-4, T-5, T-6, T-92, T-93, T-94, T-95, T-167, T-168, T-169, T-227, T-228 and T-272. Most preferred mixtures are: T-2, T-3, T-4, T-92, T-93 and T-167.

In an especially preferred embodiment, a ternary mixture is used within the methods according to the invention, wherein compound (I) is imazapyr and wherein compound (II) is pyraclostrobin and wherein compound (III) is imazethapyr, imazapic or imazamox.

In another especially preferred embodiment, a ternary mixture is used within the methods according to the invention, wherein compound (I) is imazamox and wherein compound (II) is pyraclostrobin and wherein compound (III) is imazethapyr or imazapic.

In another especially preferred embodiment, a ternary mixture is used within the methods according to the invention, wherein compound (I) is imazapic and wherein compound (II) is pyraclostrobin and wherein compound (III) is imazethapyr.

In an especially preferred embodiment, the ternary mixture used for synergistically improving the health of a plant comprises imazapyr as compound (I), pyraclostrobin as compound (II) and imazethapyr as compound (III). In another especially preferred embodiment, this ternary mixture is used for synergistically controlling undesirable vegetation in crops. In yet another especially preferred embodiment, this ternary mixture is used for synergistically controlling phytopathogenic fungi in crops.

In another especially preferred embodiment, the ternary mixture used for synergistically improving the health of a plant comprises imazapyr as compound (I), pyraclostrobin as compound (II) and imazapic as compound (III). In another especially preferred embodiment, this ternary mixture is used for synergistically controlling undesirable vegetation in crops. In yet another especially preferred embodiment, this ternary mixture is used for synergistically controlling phytopathogenic fungi in crops.

In another especially preferred embodiment, the ternary mixture used for synergistically improving the health of plants comprises imazapyr as compound (I), pyraclostrobin as compound (II) and imazamox as compound (III). In another especially preferred embodiment, this binary mixture is used for synergistically controlling undesirable vegetation in crops. In yet another especially preferred embodiment, this binary mixture is used for synergistically controlling phytopathogenic fungi in crops.

In another especially preferred embodiment, the ternary mixture used for synergistically improving the health of a plant comprises imazamox as compound (I), pyraclostrobin as compound (II) and imazethapyr as compound (III). In another especially preferred embodiment, this ternary mixture is used for synergistically controlling undesirable vegetation in crops. In yet another especially preferred embodiment, this ternary mixture is used for synergistically controlling phytopathogenic fungi in crops.

In another especially preferred embodiment, the ternary mixture used for synergistically improving the health of a plant comprises imazapic as compound (I), pyraclostrobin as compound (II) and imazethapyr as compound (III). In another especially preferred embodiment, this ternary mixture is used for synergistically controlling undesirable vegetation in crops. In yet another especially preferred embodiment, this ternary mixture is used for synergistically controlling phytopathogenic fungi in crops.

In another especially preferred embodiment, the ternary mixture used for synergistically improving the health of a plant comprises imazapic as compound (I), pyraclostrobin as compound (II) and imazamox as compound (III). In another especially preferred embodiment, this ternary mixture is used for synergistically controlling undesirable vegetation in crops. In yet another especially preferred embodiment, this ternary mixture is used for synergistically controlling phytopathogenic fungi in crops.

The remarks as to preferred mixtures comprising compounds selected from the groups consisting of compounds (I), (II) and (III), to their preferred use and methods of using them are to be understood either each on their own or preferably in combination with each other.

In the terms of the present invention “mixture” is not restricted to a physical mixture comprising one compound (I) and one compound (II) and/or one compound (III) but refers to any preparation form of one compound (I) and one compound (II) and/or one compound (III), the use of which is time- and locus-related.

In one embodiment of the invention “mixture” refers to a binary mixture comprising one compound (I) and one compound (II).

In another embodiment of the invention, “mixture” refers to a ternary mixture comprising one compound (I) and one compound (II) and one compound (III).

In another embodiment of the invention, “mixture” refers to one compound (I) and one compound (II) and/or one compound (III) formulated separately but applied to the same plant, plant propagule or locus in a temporal relationship, i.e. simultaneously or subsequently, the subsequent application having a time interval which allows a combined action of the compounds.

In another embodiment of the invention, one compound (I) and one compound (II) and/or one compound (III) are applied simultaneously, either as a mixture or separately, or subsequently to plant propagules.

In a preferred embodiment of the invention, one compound (I) and one compound (II) and/or one compound (III) are applied simultaneously, either as a mixture or separately, as foliar spray treatment.

Furthermore, the individual compounds of the mixtures according to the invention such as parts of a kit or parts of the binary or ternary mixture may be mixed by the user himself in a spray tank and further auxiliaries may be added if appropriate (tank mix).

As set forth above, the present invention relates to a method of increasing the health of plants by treating plants, parts of such plants, plant propagation materials, or their locus of growth with an inventive mixture.

Preferably, the present invention relates to a method of increasing the yield of plants by treating plants, parts of such plants, plant propagation materials, or their locus of growth with an inventive mixture.

In a further preferred embodiment, the present invention relates to a method for improving the health of a plant, in particular for increasing the yield of plants, by treating plants, parts of such plants or their locus of growth with compound (I) and plant propagation materials, preferably seeds with compound (II) and optionally compound (III).

“Plant health” is intended to mean a condition of the plant which is determined by several aspects alone or in combination with each other. For example, advantageous properties that may be mentioned are improved crop characteristics including: emergence, protein content, oil content, starch content, more developed root system (improved root growth), improved stress tolerance (e.g. against drought, heat, salt, UV, water, cold), reduced ethylene (reduced production and/or inhibition of reception), tillering increase, increase in plant height, bigger leaf blade, less dead basal leaves, stronger tillers, greener leaf color, pigment content, photosynthetic activity, less input needed (such as fertilizers or water), less plant propagation materials (preferably seeds) needed, more productive tillers, earlier flowering, early grain maturity, less plant verse (lodging), increased shoot growth, enhanced plant vigor, increased plant stand and early and better germination, yield; or any other advantages familiar to a person skilled in the art.

For the present invention, a particular important aspect of plant health is yield. Yield is is crop and/or fruit yield. “Crop” and “fruit” are to be understood as any plant product which is further utilized after harvesting, e.g. fruits in the proper sense, vegetables, nuts, grains, seeds, wood (e.g. in the case of silviculture plants), flowers (e.g. in the case of gardening plants, ornamentals) etc., that is anything of economic value that is produced by the plant. In a preferred embodiment, the term yield refers to fruits in the proper sense, vegetables, nuts, grains and seeds.

The term “plants” generally comprises all plants of economic importance and/or men-grown plants. They are preferably selected from agricultural, silvicultural and ornamental plants, more preferably agricultural plants and silvicultural plants, utmost preferably agricultural plants. The term “plant (or plants)” is a synonym of the term “crop” which is to be understood as a plant of economic importance and/or a men-grown plant. The term “plant” as used herein includes all parts of a plant such as germinating seeds, emerging seedlings, herbaceous vegetation as well as established woody plants including all belowground portions (such as the roots) and aboveground portions.

The plants to be treated according to the invention are selected from the group consisting of agricultural, silvicultural, ornamental and horticultural plants, each in its natural or genetically modified form, more preferably from agricultural plants.

In one embodiment, the aforementioned methods for increasing the health of a plant and/or increasing the control of undesirable vegetation and/or increasing the control of phytopathogenic fungi comprises treating the plant propagules, preferably the seeds of an agricultural, horticultural, ornamental or silivcultural plant selected from the group consisting of transgenic or non-transgenic plants with a mixture according to the present invention.

In one embodiment, the plant to be treated according to the method of the invention is an agricultural plant. Agricultural plants are plants of which a part or all is harvested or cultivated on a commercial scale or which serve as an important source of feed, food, fibres (e.g. cotton, linen), combustibles (e.g. wood, bioethanol, biodiesel, biomass) or other chemical compounds. Agricultural plants also horticultural plants, i.e. plants grown in gardens (and not on fields), such as certain fruits and vegetables. Preferred agricultural plants are for example cereals, e.g. wheat, rye, barley, triticale, oats, sorghum or rice; beet, e.g. sugar beet or fodder beet; fruits, such as pomes, stone fruits or soft fruits, e.g. apples, pears, plums, peaches, almonds, cherries, strawberries, raspberries, blackberries or gooseberries; leguminous plants, such as lentils, peas, alfalfa or soybeans; oil plants, such as rape, oil-seed rape, canola, juncea (Brassica juncea), linseed, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, canola, sugar cane or oil palm; corn; tobacco; nuts; coffee; tea; bananas; vines (table grapes and grape juice grape vines); hop; turf; natural rubber plants or ornamental and forestry plants, such as flowers, shrubs, broad-leaved trees or evergreens, e.g. conifers; and on the plant propagation material, such as seeds, and the crop material of these plants.

More preferred agricultural plants are field crops, such as potatoes, sugar beets, cereals such as wheat, rye, barley, triticale, oats, sorghum, rice, corn, cotton, rape, sunflowers, oilseed rape, juncea and canola, legumes such as soybeans, peas and beans (fieldbeans), lentil, sugar cane, turf; ornamentals; or vegetables, such as cucumbers, tomatoes, or onions, leeks, lettuce, squashes, alfalfa, clover most preferred agricultural plants are potatoes, beans (fieldbeans), alfalfa, sugar cane, turf, sugar beets, cereals such as wheat, rye, triticale, barley, oats, sorghum, rice, corn, cotton, soybeans, oilseed rape, canola, juncea, sunflower, sugar cane, peas, lentils and alfalfa and utmost preferred plants are selected from soybean, wheat, sunflowers, canola, juncea, corn, cotton, sugar cane, peas, lentils and alfalfa and oilseed rape.

In another preferred embodiment of the present invention, the plants to be treated are selected from soybean, wheat, sunflower, canola, oilseed rape, corn, cotton, sugar cane, juncea, peas, lentils and alfalfa. The utmost preferred plant is soybean.

In an especially preferred embodiment of the present invention, the plants to be treated are selected from wheat, barley, corn, soybean, rice, canola and sunflower.

In one embodiment, the plant to be treated according to the method of the invention is a horticultural plant. The term “horticultural plants” are to be understood as plants which are commonly used in horticulture—e.g. the cultivation of ornamentals, vegetables and/or fruits. Examples for ornamentals are turf, geranium, pelargonia, petunia, begonia and fuchsia. Examples for vegetables are potatoes, tomatoes, peppers, cucurbits, cucumbers, melons, watermelons, garlic, onions, carrots, cabbage, beans, peas and lettuce and more preferably from tomatoes, onions, peas and lettuce. Examples for fruits are apples, pears, cherries, strawberry, citrus, peaches, apricots and blueberries.

In one embodiment, the plant to be treated according to the method of the invention is an ornamental plant. “Ornamental plants” are plants which are commonly used in gardening, e.g. in parks, gardens and on balconies. Examples are turf, geranium, pelargonia, petunia, begonia and fuchsia.

In one embodiment, the plant to be treated according to the method of the invention is a silvicultural plants. The term “silvicultural plant” is to be understood as trees, more specifically trees used in reforestation or industrial plantations. Industrial plantations generally serve for the commercial production of forest products, such as wood, pulp, paper, rubber tree, Christmas trees, or young trees for gardening purposes. Examples for silvicultural plants are conifers, like pines, in particular Pinus spec., fir and spruce, eucalyptus, tropical trees like teak, rubber tree, oil palm, willow (Salix), in particular Salix spec., poplar (cottonwood), in particular Populus spec., beech, in particular Fagus spec., birch, oil palm and oak.

In a preferred embodiment of the invention, the plant to be treated is a herbicide tolerant plant. Within the herbicide tolerant plants, imidazolinone tolerant plants are especially preferred. Imidazolinone tolerant plants are tolerant to at least one imidazolinone herbicide (compound I) selected from the group consisting of imazamethabenz-methyl, imazamox, imazapic, imazapyr, imazaquin and imazethapyr.

The term “locus” is to be understood as any type of environment, soil, area or material where the plant is growing or intended to grow as well as the environmental conditions (such as temperature, water availability, radiation) that have an influence on the growth and development of the plant and/or its propagules.

In the terms of the present invention “mixture” means a combination of at least two active ingredients (components). In the present case, a mixture comprises one compound (I) and one compound (II) or one compound (I) and one compound (II) and one compound (III).

The term “genetically modified plants” is to be understood as plants, which genetic material has been modified by the use of recombinant DNA techniques in a way that under natural circumstances it cannot readily be obtained by cross breeding, mutations or natural recombination.

The term “plant propagation material” is to be understood to denote all the generative parts of the plant such as seeds and vegetative plant material such as cuttings and tubers (e.g. potatoes), which can be used for the multiplication of the plant. This includes seeds, grains, roots, fruits, tubers, bulbs, rhizomes, cuttings, spores, offshoots, shoots, sprouts and other parts of plants, including seedlings and young plants, which are to be transplanted after germination or after emergence from soil, meristem tissues, single and multiple plant cells and any other plant tissue from which a complete plant can be obtained.

The term “propagules” or “plant propagules” is to be understood to denote any structure with the capacity to give rise to a new plant, e.g. a seed, a spore, or a part of the vegetative body capable of independent growth if detached from the parent. In a preferred embodiment, the term “propagules” or “plant propagules” denotes for seed.

The term “synergistically” means that the purely additive increasing effects of a simultaneous, that is joint or separate application of one compound (I) and one compound (II) and optionally one compound (III), or the successive application of one compound (I) and one compound (II) and optionally one compound (III), is surpassed by the application of a mixture according to the invention.

The term “health of a plant” or “plant health” is defined as a condition of the plant and/or its products which is determined by several aspects alone or in combination with each other such as yield, plant vigor, quality and tolerance to abiotic and/or biotic stress.

The above identified indicators for the health condition of a plant may be interdependent or they may result from each other. Each listed plant health indicator listed below, and which is selected from the groups consisting of yield, plant vigor, quality and tolerance to abiotic and/or biotic stress, is to be understood as a preferred embodiment of the present invention either each on its own or preferably in combination with each other.

One indicator for the condition of the plant is the yield. “Yield” is to be understood as any plant product of economic value that is produced by the plant such as grains, fruits in the proper sense, vegetables, nuts, grains, seeds, wood (e.g. in the case of silviculture plants) or even flowers (e.g. in the case of gardening plants, ornamentals). The plant products may in addition be further utilized and/or processed after harvesting.

According to the present invention, “increased yield” of a plant, in particular of an agricultural, silvicultural and/or horticultural plant means that the yield of a product of the respective plant is increased by a measurable amount over the yield of the same product of the plant produced under the same conditions, but without the application of the mixture according to the invention.

Increased yield can be characterized, among others, by the following improved properties of the plant:
increased plant weight
increased plant height
increased biomass such as higher overall fresh weight (FW)
increased number of flowers per plant
higher grain yield
more tillers or side shoots (branches)
larger leaves
increased shoot growth
increased protein content
increased oil content
increased starch content
increased pigment content

According to the present invention, the yield is increased by at least 4%, preferable by 5 to 10%, more preferable by 10 to 20%, or even 20 to 30%. In general, the yield increase may even be higher.

Another indicator for the condition of the plant is the plant vigor. The plant vigor becomes manifest in several aspects such as the general visual appearance.

Improved plant vigor can be characterized, among others, by the following improved properties of the plant:
improved vitality of the plant
improved plant growth
improved plant development
improved visual appearance
improved plant stand (less plant verse/lodging)
improved emergence
enhanced root growth and/or more developed root system enhanced nodulation, in particular rhizobial nodulation
bigger leaf blade
bigger size
increased plant weight
increased plant height
increased tiller number
increased number of side shoots
increased number of flowers per plant
increased shoot growth
increased root growth (extensive root system)
increased yield when grown on poor soils or unfavorable climate
enhanced photosynthetic activity (e.g. based on increased stomatal conductance and/or increased CO₂ assimilation rate)
increased stomatal conductance
increased CO₂ assimilation rate
enhanced pigment content (e.g. chlorophyll content)
earlier flowering
earlier fruiting
earlier and improved germination
earlier grain maturity
improved self-defense mechanisms
improved stress tolerance and resistance of the plants against biotic and abiotic stress factors such as fungi, bacteria, viruses, insects, heat stress, cold stress, drought stress, UV stress and/or salt stress
less non-productive tillers
less dead basal leaves
less input needed (such as fertilizers or water)
greener leaves
complete maturation under shortened vegetation periods
less fertilizers needed
less seeds needed
easier harvesting
faster and more uniform ripening
longer shelf-life
longer panicles
delay of senescence
stronger and/or more productive tillers
better extractability of ingredients
improved quality of seeds (for being seeded in the following seasons for seed production)
reduced production of ethylene and/or the inhibition of its reception by the plant.

The improvement of the plant vigor according to the present invention particularly means that the improvement of any one or several or all of the above mentioned plant characteristics are improved independently of the pesticidal action of the mixture or active ingredients (components).

Another indicator for the condition of the plant is the “quality” of a plant and/or its products. According to the present invention, enhanced quality means that certain plant characteristics such as the content or composition of certain ingredients are increased or improved by a measurable or noticeable amount over the same factor of the plant produced under the same conditions, but without the application of the mixtures of the present invention. Enhanced quality can be characterized, among others, by following improved properties of the plant or its product:
increased nutrient content
increased protein content
increased content of fatty acids
increased metabolite content
increased carotenoid content
increased sugar content
increased amount of essential amino acids
improved nutrient composition
improved protein composition
improved composition of fatty acids
improved metabolite composition
improved carotenoid composition
improved sugar composition
improved amino acids composition
improved or optimal fruit color
improved leaf color
higher storage capacity
higher processability of the harvested products.

Another indicator for the condition of the plant is the plant's tolerance or resistance to biotic and/or abiotic stress factors. Biotic and abiotic stress, especially over longer terms, can have harmful effects on plants. Biotic stress is caused by living organisms while abiotic stress is caused for example by environmental extremes. According to the present invention, “enhanced tolerance or resistance to biotic and/or abiotic stress factors” means (1.) that certain negative factors caused by biotic and/or abiotic stress are diminished in a measurable or noticeable amount as compared to plants exposed to the same conditions, but without being treated with a mixture according to the invention and (2.) that the negative effects are not diminished by a direct action of the mixture according to the invention on the stress factors, e.g. by its fungicidal or insecticidal action which directly destroys the microorganisms or pests, but rather by a stimulation of the plants' own defensive reactions against said stress factors.

Negative factors caused by biotic stress such as pathogens and pests are widely known and range from dotted leaves to total destruction of the plant. Biotic stress can be caused by living organisms, such as:
pests (for example insects, arachnides, nematodes)
competing plants (for example weeds)
microorganisms such as phythopathogenic fungi and/or bacteria
viruses.

Negative factors caused by abiotic stress are also well-known and can often be observed as reduced plant vigor (see above), for example: dotted leaves, “burned leaves”, reduced growth, less flowers, less biomass, less crop yields, reduced nutritional value of the crops, later crop maturity, to give just a few examples. Abiotic stress can be caused for example by:
extremes in temperature such as heat or cold (heat stress/cold stress)
strong variations in temperature
temperatures unusual for the specific season
drought (drought stress)
extreme wetness
high salinity (salt stress)
radiation (for example by increased UV radiation due to the decreasing ozone layer)
increased ozone levels (ozone stress)
organic pollution (for example by phythotoxic amounts of pesticides)
inorganic pollution (for example by heavy metal contaminants).

As a result of biotic and/or abiotic stress factors, the quantity and the quality of the stressed plants, their crops and fruits decrease. As far as quality is concerned, reproductive development is usually severely affected with consequences on the crops which are important for fruits or seeds. Synthesis, accumulation and storage of proteins are mostly affected by temperature; growth is slowed by almost all types of stress; polysaccharide synthesis, both structural and storage is reduced or modified: these effects result in a decrease in biomass (yield) and in changes in the nutritional value of the product.

Advantageous properties, obtained especially from treated seeds, are e.g. improved germination and field establishment, better vigor and/or a more homogen field establishment.

As pointed out above, the above identified indicators for the health condition of a plant may be interdependent and may result from each other. For example, an increased resistance to biotic and/or abiotic stress may lead to a better plant vigor, e.g. to better and bigger crops, and thus to an increased yield. Inversely, a more developed root system may result in an increased resistance to biotic and/or abiotic stress. However, these interdependencies and interactions are neither all known nor fully understood and therefore the different indicators are described separately.

In one embodiment the use of the mixtures within the methods according to the invention results in an increased yield of a plant or its product.

In another embodiment the use of the mixtures within the methods according to the invention results in an increased vigor of a plant or its product.

In another embodiment the use of the mixtures within the methods according to the invention results in an increased quality of a plant or its product.

In yet another embodiment the use of the mixtures within the methods according to the invention results in an increased tolerance and/or resistance of a plant or its product against biotic and/or abiotic stress.

In one embodiment of the invention, the tolerance and/or resistance against biotic stress factors is enhanced. Thus, according to a preferred embodiment of the present invention, the inventive mixtures are used for stimulating the natural defensive reactions of a plant against a pathogen and/or a pest. As a consequence, the plant can be protected against unwanted microorganisms such as phytopathogenic fungi and/or bacteria or even viruses and/or against pests such as insects, arachnids and nematodes.

In another embodiment of the invention, the tolerance and/or resistance against abiotic stress factors is enhanced. Thus, according to a preferred embodiment of the present invention, the inventive mixtures are used for stimulating a plant's own defensive reactions against abiotic stress such as extremes in temperature, e.g. heat or cold or strong variations in temperature and/or temperatures unusual for the specific season, drought, extreme wetness, high salinity, radiation (e.g. increased UV radiation due to the decreasing ozone protective layer), increased ozone levels, organic pollution (e.g. by phythotoxic amounts of pesticides) and/or inorganic pollution (e.g. by heavy metal contaminants).

In a preferred embodiment of the invention, the mixtures according to the invention are used for increasing the yield such as the plant weight and/or the plant biomass (e.g. overall fresh weight) and/or the grain yield and/or the number of tillers.

In another preferred embodiment of the invention, the mixtures according to the invention are used for improving the plant vigor such as the vitality of the plant and/or the plant development and/or the visual appearance and/or the plant stand (less plant verse/lodging) and/or enhancing root growth and/or improving the development of the root system and/or increasing the shoot growth and/or increasing the number of flowers per plant and/or increasing the yield of the crop when grown on poor soils or unfavorable climates and/or increased photosynthetic activity and/or enhancing the pigment content and/or increasing the chlorophyll content and/or increasing the stomatal conductance and/or improving the flowering (earlier flowering) and/or improving the germination and/or improving the stress tolerance and resistance of the plants against biotic and abiotic stress factors such as fungi, bacteria, viruses, insects, heat stress, cold stress, drought stress, UV stress and/or salt stress and/or decreasing the number of non-productive tillers and/or decreasing the number of dead basal leaves and/or increasing greenness of the leaves and/or reducing the input needed such as fertilizer and water and/or reducing the seed needed to establish the crop and/or improving the harvestability of the crop and/or improving the uniformity of ripening and/or improving the shelf life and/or delaying the senescence and/or strengthening the productive tillers and/or improving the quality of seeds in seed production and/or improving fruit color and/or improving leaf color and/or improving storage capacity and/or improving processability of the harvested product.

In an especially preferred embodiment of the invention, the mixtures according to the invention are used for increasing the stomatal conductance. Higher stomatal conductance increases CO₂ diffusion into the leaf and favors higher photosynthetic rates. Higher photosynthetic rates in turn favor a higher biomass and higher crop yields. Recent studies of Pima cotton (Gossypium barbadense) and bread wheat (Triticum aestivum) have shown a positive correlation between yield increase and increases in stomatal conductance (Lu et al. (1998): Stomatal conductance predicts yields in irrigated Pima cotton and bread wheat grown at high temperatures. J. Exp. Bot. 49: 453-460).

In another especially preferred embodiment of the invention, the mixtures according to the invention are used for increasing the chlorophyll content. It is well known that chlorophyll content has a positive correlation with the plant's photosynthesis rate and accordingly, as pointed out above, to the plant's yield. The higher the chlorophyll content the higher the yield of a plant.

In an even more preferred embodiment of the invention, the mixtures according to the invention are used for increasing the plant weight and/or increasing the plant's biomass (e.g. overall fresh weight) and/or increasing the grain yield and/or increasing the number of tillers and/or improving the plant development and/or improving the visual appearance and/or improving the plant stand (less plant verse/lodging) and/or increasing the yield of the crop when grown on poor soils or unfavorable climates and/or improving the germination and/or improving the stress tolerance and resistance of the plants against abiotic stress factors such as cold stress, drought stress, UV stress and/or decreasing the number of non-productive tillers and/or decreasing the number of dead basal leaves and/or improving the greenness of the leaves and/or reducing the seed needed to establish the crop and/or improving the harvestability of the crop and/or improving the shelf life and/or delaying the senescence and/or strengthening the productive tillers and/or improving the quality of seeds in seed production.

It has to be emphasized that the above mentioned effects of the mixtures according to the invention, i.e. enhanced health of the plant, are also present when the plant is not under biotic stress and in particular when the plant is not under pest pressure. It is evident that a plant suffering from fungal or insecticidal attack produces a smaller biomass and leads to a reduced crop yield as compared to a plant which has been subjected to curative or preventive treatment against the pathogenic fungus or any other relevant pest and which can grow without the damage caused by the biotic stress factor. However, the methods according to the invention lead to an enhanced plant health even in the absence of any biotic stress. This means that the positive effects of the mixtures of the invention cannot be explained just by the fungicidal and/or herbicidal activities of the compounds (I) and (II), but are based on further activity profiles. Accordingly, in a preferred embodiment of the method, the application of the active ingredients (components) and/or their mixtures is carried out in the absence of pest pressure. But of course, plants under biotic stress can be treated, too, according to the methods of the present invention.

The active substance combinations according to the invention have very good fungicidal properties and can be employed for controlling phytopathogenic fungi such as Plasmodiophoromycetes, Oomycetes, Chytridiomycetes, Zygomycetes, Ascomycetes, Basidiomycetes, Deuteromycetes and the like.

Examples which may be mentioned, but not by limitation, of some pathogens of fungal diseases which come under the abovementioned general terms are:

Diseases caused by powdery mildew pathogens, such as, for example, Blumeria species such as, for example, Blumeria graminis; Podosphaera species such as, for example, Podosphaera leucotricha; Sphaerotheca species such as, for example, Sphaerotheca fuliginea; Uncinula species such as, for example, Uncinula necator;
Diseases caused by rust pathogens such as, for example, Gymnosporangium species such as, for example, Gymnosporangium sabinae; Hemileia species such as, for example, Hemileia vastatrix;
Phakopsora species such as, for example, Phakopsora pachyrhizi and Phakopsora meibomiae; Puccinia species such as, for example, Puccinia recondita;
Puccinia striiformis or Puccinia graminis;
Uromyces species such as, for example, Uromyces appendiculatus;
Diseases caused by pathogens from the Oomycetae group such as, for example, Bremia species such as, for example, Bremia lactucae; Peronospora species such as, for example, Peronospora pisi or P. brassicae;
Phytophthora species such as, for example, Phytophthora infestans;
Plasmopara species such as, for example, Plasmopara viticola;
Pseudoperonospora species such as, for example, Pseudoperonospora humuli or Pseudoperonospora cubensis; Pythium species such as, for example, Pythium ultimum;
Leaf spot diseases and leaf wilts caused by, for example, Alternaria species such as, for example, Alternaria solani;
Cercospora species such as, for example, Cercospora beticola; Cladosporum species such as, for example, Cladosporium cucumerinum;
Cochliobolus species such as, for example, Cochliobolus sativus (conidial form: Drechslera, syn: Helminthosporium);
Colletotrichum species such as, for example, Colletotrichum lindemuthanium;
Cycloconium species such as, for example, Cycloconium oleaginum; Diaporthe species such as, for example, Diaporthe citri; Elsinoe species such as, for example, Elsinoe fawcettii; Gloeosporium species such as, for example, Gloeosporium laeticolor;
Glomerella species such as, for example, Glomerella cingulata;
Guignardia species such as, for example, Guignardia bidwelli; Leptosphaeria species such as, for example, Leptosphaeria maculans;
Magnaporthe species such as, for example, Magnaporthe grisea; Mycosphaerella species such as, for example, Mycosphaerelle graminicola; Phaeosphaeria species such as, for example, Phaeosphaeria nodorum; Pyrenophora species such as, for example, Pyrenophora teres; Ramularia species such as, for example, Ramularia collo-cygni; Rhynchosporium species such as, for example, Rhynchosporium secalis; Septoria species such as, for example, Septoria apii; Typhula species such as, for example,
Typhula incarnata; Venturia species such as, for example, Venturia inaequalis; Root and stem diseases caused by, for example,
Corticium species such as, for example, Corticium graminearum;
Fusarium species such as, for example, Fusarium oxysporum;
Gaeumannomyces species such as, for example, Gaeumannomyces graminis; Rhizoctonia species such as, for example, Rhizoctonia solani; Tapesia species such as, for example, Tapesia acuformis;
Thielaviopsis species such as, for example, Thielaviopsis basicola;
Ear and panicle diseases (including maize cobs), caused by, for example, Alternaria species such as, for example, Alternaria spp.; Aspergillus species such as, for example, Aspergillus flavus;
Cladosporium species such as, for example, Cladosporium spp.; Claviceps species such as, for example, Claviceps purpurea;
Fusarium species such as, for example, Fusarium culmorum;
Gibberella species such as, for example, Gibberella zeae; Monographella species such as, for example, Monographella nivalis;
Diseases caused by smuts such as, for example, Sphacelotheca species such as, for example, Sphacelotheca reiliana; Tilletia species such as, for example, Tilletia caries; Urocystis species such as, for example, Urocystis occulta; Ustilago species such as, for example, Ustilago nuda;
Fruit rot caused by, for example, Aspergillus species such as, for example, Aspergillus flavus; Botrytis species such as, for example, Botrytis cinerea;
Penicillium species such as, for example, Penicillium expansum;
Sclerotinia species such as, for example, Sclerotinia sclerotiorum; Verticilium species such as, for example, Verticilium alboatrum;
Seed- and soil-borne rot and wilts, and seedling diseases, caused by, for example, Fusarium species such as, for example, Fusarium culmorum;
Phytophthora species such as, for example, Phytophthora cactorum; Pythium species such as, for example, Pythium ultimum; Rhizoctonia species such as, for example, Rhizoctonia solani; Sclerotium species such as, for example, Sclerotium rolfsii; Cankers, galls and witches' broom disease, caused by, for example, Nectria species such as, for example, Nectria galligena;
Wilts caused by, for example, Monilinia species such as, for example, Monilinia laxa; Deformations of leaves, flowers and fruits, caused by, for example, Taphrina species such as, for example, Taphrina deformans;
Degenerative diseases of woody species, caused by, for example, Esca species such as, for example, Phaemoniella clamydospora;
Diseases of inflorescences and seeds, caused by, for example, Botrytis species such as, for example, Botrytis cinerea;
Diseases of the plant tubers, caused by, for example, Rhizoctonia species such as, for example, Rhizoctonia solani;

The invention furthermore relates to a method for controlling undesirable vegetation, which comprises applying an herbicidal composition according to the present invention to the undesirable plants. Application can be done before, during and/or after, preferably during and/or after, the emergence of the undesirable plants.

The invention in particular relates to a method for controlling undesirable vegetation in crops, which comprises applying an herbicidal composition according to the present invention in crops where undesirable vegetation occurs or might occur.

The invention furthermore relates to a method for controlling undesirable vegetation, which comprises allowing a composition according to the present invention to act on plants, their habitat or on seed.

The compositions of the present invention are suitable for controlling a large number of harmful plants, including monocotyledonous weeds, in particular annual weeds such as gramineous weeds (grasses) including Echinochloa species such as barnyardgrass (Echinochloa crusgalli var. crus-galli), Digitaria species such as crabgrass (Digitaria sanguinalis), Setaria species such as green foxtail (Setaria viridis) and giant foxtail (Setaria faberii), Sorghum species such as johnsongrass (Sorghum halepense Pers.), Avena species such as wild oats (Avena fatua), Cenchrus species such as Cenchrus echinatus, Bromus species, Lolium species, Phalaris species, Eriochloa species, Panicum species, Brachiaria species, annual bluegrass (Poa annua), blackgrass (Alopecurus myosuroides), Aegilops cylindrica, Agropyron repens, Apera spicaventi, Eleusine indica, Cynodon dactylon and the like.

The compositions of the present invention are also suitable for controlling a large number of dicotyledonous weeds, in particular broad leaf weeds including Polygonum species such as wild buckwheat (Polygonum convolvolus), Amaranthus species such as pigweed (Amaranthus retroflexus), Chenopodium species such as common lambsquarters (Chenopodium album L.), Sida species such as prickly sida (Sida spinosa L.), Ambrosia species such as common ragweed (Ambrosia artemisiifolia), Acanthospermum species, Anthemis species, Atriplex species, Cirsium species, Convolvulus species, Conyza species, Cassia species, Commelina species, Datura species, Euphorbia species, Geranium species, Galinsoga species, morningglory (Ipomoea species), Lamium species, Malva species, Matricaria species, Sysimbrium species, Solanum species, Xanthium species, Veronica species, Viola species, common chickweed (Stellaria media), velvetleaf (Abutilon theophrasti), Hemp sesbania (Sesbania exaltata Cory), Anoda cristata, Bidens pilosa, Brassica kaber, Capsella bursa-pastoris, Centaurea cyanus, Galeopsis tetrahit, Galium aparine, Helianthus annuus, Desmodium tortuosum, Kochia scoparia, Mercurialis annua, Myosotis arvensis, Papaver rhoeas, Raphanus raphanistrum, Salsola kali, Sinapis arvensis, Sonchus arvensis, Thlaspi arvense, Tagetes minuta, Richardia brasiliensis, and the like.

The compositions of the present invention are also suitable for controlling a large number of annual and perennial sedge weeds including cyperus species such as purple nutsedge (Cyperus rotundus L.), yellow nutsedge (Cyperus esculentus L.), hime-kugu (Cyperus brevifolius H.), sedge weed (Cyperus microiria Steud), rice flatsedge (Cyperus iria L.), and the like.

The compositions of the present invention are suitable for combating/controlling undesired vegetation in wheat, barley, rye, triticale, oats, durum, rice, corn, sugarcane, sorghum, soybean, pulse crops such as pea, bean and lentils, peanut, sunflower, sugarbeet, potato, cotton, brassica crops, such as oilseed rape, canola, mustard, cabbage and turnip, turf, grapes, pomefruit, such as apple and pear, stonefruit, such as peach, almond, walnut, olive, cherry, plum and apricot, citrus, coffee, pistachio, garden ornamentals, such as roses, petunia, marigold, snap dragon, bulb ornamentals such as tulips and narcissus, conifers and deciduous trees such as pinus, fir, oak, maple, dogwood, hawthorne, crabapple and rhamnus, particularly in soybean, sunflower, corn, cotton, canola, sugarcane, sugarbeet, pomefruit, barley, oats, sorghum, rice and wheat. The utmost preferred plant is soybean.

The compositions can be applied pre- or post-emergence, i.e. before, during and/or after emergence of the undesirable plants. When the compositions are used in crops, they can be applied after seeding and before or after the emergence of the crop plants. The compositions invention can, however, also be applied prior to seeding of the crop plants.

The inventive mixtures are employed by treating the plant, plant propagation material (preferably seed), soil, area, material or environment in which a plant is growing or may grow with an effective amount of the active compounds. The application can be carried out in the absense of pest pressure and/or both before and after an infection of the materials, plants or plant propagation materials (preferably seeds) by pests.

In a preferred embodiment of the method, the aerial plant parts are treated with a mixture according to the invention.

Another preferred embodiment of the method comprises seed treatment with compound (II) followed by foliar spraying of the soil, area, material or environment in which a plant is growing or may grow with compound (I) and optinonally with compound (III).

In a further preferred embodiment, the present invention relates to a method of increasing the health of plants by treating plants, parts of such plants or at their locus of growth with compound (I) and plant propagation materials (preferably seeds) with compound (II) and optinonally with compound (III).

The term “BBCH principal growth stage” refers to the extended BBCH-scale which is a system for a uniform coding of phenologically similar growth stages of all mono- and dicotyledonous plant species in which the entire developmental cycle of the plants is subdivided into clearly recognizable and distinguishable longer-lasting developmental phases. The BBCH-scale uses a decimal code system, which is divided into principal and secondary growth stages. The abbreviation BBCH derives from the Federal Biological Research Centre for Agriculture and Forestry (Germany), the Bundessortenamt (Germany) and the chemical industry.

In one embodiment of the invention, a mixture according to the invention is applied at a growth stage (GS) between GS 00 and GS 65 BBCH of the treated plant.

In a preferred embodiment of the invention, a mixture according to the invention is applied at a growth stage (GS) between GS 00 and GS 55 BBCH of the treated plant.

In an even more preferred embodiment of the invention, a mixture according to the invention is applied at a growth stage (GS) between GS 00 and GS 37 BBCH of the treated plant.

In a most preferred embodiment of the invention, a mixture according to the invention is applied at a growth stage (GS) between GS 00 and GS 21 BBCH of the treated plant.

The invention furthermore relates to the use of the mixtures as defined above for controlling undesirable vegetation, which comprises applying the mixtures according to the present invention to the undesirable plants. Application can be done before, during and/or after, preferably during and/or after, the emergence of the undesirable plants.

The invention in particular relates to the use of the mixtures as defined above for controlling undesirable vegetation in crops, which comprises applying a mixture according to the present invention in crops where undesirable vegetation occurs or might occur.

In one embodiment of the method according to the invention, the plants and/or plant propagules are treated simultaneously (together or separately) or subsequently with a mixture as described above. Of course, the subsequent application is carried out with a time interval which allows a combined action of the applied compounds. Preferably, the time interval for a subsequent application of compound (I) and compound (II) and, in the case of ternary mixtures, one compound (III) ranges from a few seconds up to 3 months, preferably, from a few seconds up to 1 month, more preferably from a few seconds up to 2 weeks, even more preferably from a few seconds up to 3 days and in particular from 1 second up to 24 hours.

Herein, we have found that simultaneous, that is joint or separate, application of a compound (I) and a compound (II) or the successive application of a compound (I) and a compound (II) allows an enhanced increase of the health of a plant and/or an increased control of undesirable vegetation and/or an increased control of phytopathogenic fungi compared to the control rates that are possible with the individual compounds (synergistic mixtures).

In another embodiment of the invention, the mixture as described above is repeatedly applied. If this is the case, the application is repeated two to five times, preferably two times.

When used for increasing the health of a plant and/or controlling undesirable vegetation and/or controlling phytopathogenic fungi, the application rates of the mixtures are between 0.3 g/ha and 1500 g/ha, depending on various parameters such as the treated plant species or the mixture applied. In a preferred embodiment of the method according to the invention, the application rates of the mixtures are between 5 g/ha and 750 g/ha. In an even more preferred embodiment of the method according to the invention, the application rates of the mixtures are between 20 g/ha and 500 g/ha, in particular from 20 g/ha to 300 g/ha.

In the treatment of plant propagation material (preferably seed), amounts of from 0.01 g to 3 kg, in particular amounts from 0.01 g to 1 kg of mixtures according to the invention are generally required per 100 kg of plant propagation material (preferably seed). In a preferred embodiment of the method according to the invention, amounts of from 0.01 g to 250 g of mixtures according to the invention are required per 100 kg of plant propagation material (preferably seed).

As a matter of course, the mixtures according to the invention are used in “effective amounts”. This means that they are used in a quantity which allows to obtain the desired effect but which does not give rise to any phytotoxic symptom on the treated plant.

The compounds according to the invention can be present in different crystal modifications whose biological activity may differ. They are likewise subject matter of the present invention.

In all binary mixtures used according to the methods of the present invention, compound (I) and compound (II) are employed in amounts which result in a synergistic effect.

With respect to binary mixtures, the weight ratio of compound (I) to compound (II) is preferably from 100:1 to 1:100, more preferably from 50:1 to 1:50, more preferably from 20:1 to 1:20 and in particular from 10:1 to 1:10. The utmost preferred ratio is 1:5 to 5:1.

In another preferred embodiment of the method according to the invention, ternary mixtures are applied. With respect to ternary mixtures, the weight ratio of compound (I) (=component 1) to compound (II) (=component 2) is preferably from 100:1 to 1:100, more preferably from 50:1 to 1:50, more preferably from 20:1 to 1:20 and in particular from 10:1 to 1:10. The utmost preferred ratio is 1:5 to 5:1. Within the ternary mixtures, the weight ratio of compound (I) (=component 1) to the further compound (III) (=component 3) is preferably from 100:1 to 1:100, more preferably from 50:1 to 1:50, more preferably from 20:1 to 1:20 and in particular from 10:1 to 1:10. The utmost preferred ratio is 1:5 to 5:1. Within the ternary mixtures, the weight ratio of compound (II) (=component 2) to the further compound (III) (=component 3) is preferably from 100:1 to 1:100, more preferably from 50:1 to 1:50, more preferably from 20:1 to 1:20 and in particular from 10:1 to 1:10. The utmost preferred ratio is 1:5 to 5:1.

The agrochemical mixtures are typically applied as compositions comprising an imidazolinone herbicide as compound (I) and a fungicidal compound (II) and optionally one compound (III). In a preferred embodiment, the pesticial composition comprises a liquid or solid carrier and a mixture as described above.

Generally the term “plants” also includes plants which have been modified by breeding, mutagenesis or genetic engineering (transgenic and non-transgenic plants). Genetically modified plants are plants, which genetic material has been modified by the use of recombinant DNA techniques in a way that it cannot readily be obtained by cross breeding under natural circumstances, mutations or natural recombination.

Plants and as well as the propagation material of said plants, which can be treated with the inventive mixtures include all modified non-transgenic plants or transgenic plants, e.g. crops which tolerate the action of herbicides or fungicides or insecticides owing to breeding, including genetic engineering methods, or plants which have modified characteristics in comparison with existing plants, which can be generated for example by traditional breeding methods and/or the generation of mutants, or by recombinant procedures.

For example, mixtures according to the present invention can be applied (as seed treatment, foliar spray treatment, in-furrow application or by any other means) also to plants which have been modified by breeding, mutagenesis or genetic engineering including but not limiting to agricultural biotech products on the market or in development (cf. http://www.bio.org/speeches/pubs/er/agri_products.asp). “Genetically modified plants” are plants, which genetic material has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-transitional modification of protein(s), oligo- or polypeptides e.g. by glycosylation or polymer additions such as prenylated, acetylated or farnesylated moieties or PEG moieties.

Plants that have been modified by breeding, mutagenesis or genetic engineering, e.g. have been rendered tolerant to applications of specific classes of herbicides. Tolerance to herbicides can be obtained by creating insensitivity at the site of action of the herbicide by expression of a target enzyme which is resistant to herbicide; rapid metabolism (conjugation or degradation) of the herbicide by expression of enzymes which inactivate herbicide; or poor uptake and translocation of the herbicide. Examples are the expression of enzymes which are tolerant to the herbicide in comparison to wild-type enzymes, such as the expression of 5-enolpyruvylshikimate-3-phosphate synthase (EPSPS), which is tolerant to glyphosate (see e.g. Heck et. al, Crop Sci. 45, 2005, 329-339; Funke et. al, PNAS 103, 2006, 13010-13015; U.S. Pat. No. 5,188,642, U.S. Pat. No. 4,940,835, U.S. Pat. No. 5,633,435, U.S. Pat. No. 5,804,425, U.S. Pat. No. 5,627,061), the expression of glutamine synthase which is tolerant to glufosinate and bialaphos (see e.g. U.S. Pat. No. 5,646,024, U.S. Pat. No. 5,561,236) and DNA constructs coding for dicamba-degrading enzymes (see for general reference US 2009/0105077, e.g. U.S. Pat. No. 7,105,724 for dicamba resistaince in bean, maize (for maize see also WO 2008/051633), cotton (for cotton see also U.S. Pat. No. 5,670,454), pea, potatoe, sorghum, soybean (for soybean see also U.S. Pat. No. 5,670,454), sunflower, tobacco, tomato (for tomato see also U.S. Pat. No. 5,670,454)).

Furthermore, this comprises also plants tolerant to applications of imidazolinone herbicides (canola (Tan et. al, Pest Manag. Sci 61, 246-257 (2005)); maize (U.S. Pat. No. 4,761,373, U.S. Pat. No. 5,304,732, U.S. Pat. No. 5,331,107, U.S. Pat. No. 5,718,079, U.S. Pat. No. 6,211,438, U.S. Pat. No. 6,211,439 and U.S. Pat. No. 6,222,100, Tan et al., Pest Manag. Sci 61, 246-257 (2005)); rice (U.S. Pat. No. 4,761,373, U.S. Pat. No. 5,304,732, U.S. Pat. No. 5,331,107, U.S. Pat. No. 5,718,079, U.S. Pat. No. 6,211,438, U.S. Pat. No. 6,211,439 and U.S. Pat. No. 6,222,100, S653N (see e.g. US 2003/0217381), S654K (see e.g. US 2003/0217381), A122T (see e.g. WO 04/106529) S653 (At)N, S654 (At)K, A122 (At)T and other resistant rice plants as described in WO0027182, WO 05/20673 and WO 01/85970 or U.S. Pat. No. 5,545,822, U.S. Pat. No. 5,736,629, U.S. Pat. No. 5,773,703, U.S. Pat. No. 5,773,704, U.S. Pat. No. 5,952,553, U.S. Pat. No. 6,274,796); millet (U.S. Pat. No. 4,761,373, U.S. Pat. No. 5,304,732, U.S. Pat. No. 5,331,107, U.S. Pat. No. 5,718,079, U.S. Pat. No. 6,211,438, U.S. Pat. No. 6,211,439 and U.S. Pat. No. 6,222,100); barley (U.S. Pat. No. 4,761,373, U.S. Pat. No. 5,304,732, U.S. Pat. No. 5,331,107, U.S. Pat. No. 5,718,079, U.S. Pat. No. 6,211,438, U.S. Pat. No. 6,211,439 and U.S. Pat. No. 6,222,100); wheat (U.S. Pat. No. 4,761,373, U.S. Pat. No. 5,304,732, U.S. Pat. No. 5,331,107, U.S. Pat. No. 5,718,079, U.S. Pat. No. 6,211,438, U.S. Pat. No. 6,211,439, U.S. Pat. No. 6,222,100, WO 04/106529, WO 04/16073, WO 03/14357, WO 03/13225 and WO 03/14356); sorghum (U.S. Pat. No. 4,761,373, U.S. Pat. No. 5,304,732, U.S. Pat. No. 5,331,107, U.S. Pat. No. 5,718,079, U.S. Pat. No. 6,211,438, U.S. Pat. No. 6,211,439 and U.S. Pat. No. 6,222,100); oats (U.S. Pat. No. 4,761,373, U.S. Pat. No. 5,304,732, U.S. Pat. No. 5,331,107, U.S. Pat. No. 5,718,079, U.S. Pat. No. 6,211,438, U.S. Pat. No. 6,211,439 and U.S. Pat. No. 6,222,100); rye (U.S. Pat. No. 4,761,373, U.S. Pat. No. 5,304,732, U.S. Pat. No. 5,331,107, U.S. Pat. No. 5,718,079, U.S. Pat. No. 6,211,438, U.S. Pat. No. 6,211,439 and U.S. Pat. No. 6,222,100); sugar beet (WO9802526/WO9802527); lentils (US2004/0187178); sunflowers (Tan et. al, Pest Manag. Sci 61, 246-257 (2005))). Gene constructs can be obtained, for example, from microorganism or plants, which are tolerant to said herbicides, such as the Agrobacterium strain CP4 EPSPS which is resistant to glyphosate; Streptomyces bacteria which are resistance to glufosinate; Arabidopsis, Daucus carotte, Pseudomonoas sp. or Zea mais with chimeric gene sequences coging for HDDP (see e.g. WO 1996/38567, WO 2004/55191); Arabidopsis thaliana which is resistant to protox inhibitors (see e.g. US 2002/0073443).

Examples of commercial available plants with tolerance to herbicides, are the corn varieties “Roundup Ready® Corn”, “Roundup Ready 2®” (Monsanto), “Agrisure GT®”, “Agrisure GT/CB/LL®”, “Agrisure GT/RW®”, “Agrisure 3000GT®” (Syngenta), “YieldGard VT Rootworm/RR2®” and “YieldGard VT Triple®” (Monsanto) with tolerance to glyphosate; the corn varieties “Liberty Link®” (Bayer), “Herculex I®”, “Herculex RW®”, “Herculex® Xtra” (Dow, Pioneer), “Agrisure GT/CB/LL®” and “Agrisure CB/LL/RW®” (Syngenta) with tolerance to glufosinate; the soybean varieties “Roundup Ready® Soybean” (Monsanto) and “Optimum GAT®” (DuPont, Pioneer) with tolerance to glyphosate; the cotton varieties “Roundup Ready® Cotton” and “Roundup Ready Flex®” (Monsanto) with tolerance to glyphosate; the cotton variety “FiberMax Liberty Link®” (Bayer) with tolerance to glufosinate; the cotton variety “BXN®” (Calgene) with tolerance to bromoxynil; the canola varieties “Navigator@” and “Compass@” (RhonePoulenc) with bromoxynil tolerance; the canola variety “Roundup Ready® Canola” (Monsanto) with glyphosate tolerance; the canola variety “InVigor®” (Bayer) with glufosinate tolerance; the rice variety “Liberty Link® Rice” (Bayer) with glulfosinate tolerance and the alfalfa variety “Roundup Ready Alfalfa” with glyphosate tolerance. Further modified plants with herbicide are commonly known, for instance alfalfa, apple, eucalyptus, flax, grape, lentils, oil seed rape, peas, potato, rice, sugar beet, sunflower, tobacco, tomatom turf grass and wheat with tolerance to glyphosate (see e.g. U.S. Pat. No. 5,188,642, U.S. Pat. No. 4,940,835, U.S. Pat. No. 5,633,435, U.S. Pat. No. 5,804,425, U.S. Pat. No. 5,627,061); beans, soybean, cotton, peas, potato, sunflower, tomato, tobacco, corn, sorghum and sugarcane with tolerance to dicamba (see e.g. US 2009/0105077, U.S. Pat. No. 7,105,724 and U.S. Pat. No. 5,670,454); pepper, apple, tomato, hirse, sunflower, tobacco, potato, corn, cucumber, wheat, soybean and sorghum with tolerance to 2,4-D (see e.g. U.S. Pat. No. 6,153,401, U.S. Pat. No. 6,100,446, WO 05/107437, U.S. Pat. No. 5,608,147 and U.S. Pat. No. 5,670,454); sugarbeet, potato, tomato and tobacco with tolerance to gluphosinate (see e.g. U.S. Pat. No. 5,646,024, U.S. Pat. No. 5,561,236); canola, barley, cotton, juncea, lettuce, lentils, melon, millet, oats, oilseed rapre, potato, rice, rye, sorghum, soybean, sugarbeet, sunflower, tobacco, tomato and wheat with tolerance to acetolactate synthase (ALS) inhibiting herbicides, such as triazolopyrimidine sulfonamides, growth inhibitors and imidazolinones (see e.g. U.S. Pat. No. 5,013,659, WO 06/060634, U.S. Pat. No. 4,761,373, U.S. Pat. No. 5,304,732, U.S. Pat. No. 6,211,438, U.S. Pat. No. 6,211,439 and U.S. Pat. No. 6,222,100); cereal, sugar cane, rice, corn, tobacco, soybean, cotton, rapeseed, sugar beet and potato with tolerance to HPPD inhibitor herbicides (see e.g. WO 04/055191, WO 96/38567, WO 97/049816 and U.S. Pat. No. 6,791,014); wheat, soybean, cotton, sugar beet, rape, rice, corn, sorghum and sugar cane with tolerance to protoporphyrinogen oxidase (PPO) inhibitor herbicides (see e.g. US2002/0073443, US 20080052798, Pest Management Science, 61, 2005, 277-285). The methods of producing such herbicide resistant plants are generally known to the person skilled in the art and are described, for example, in the publications mentioned above.

Further examples of commercial available modified plants with tolerance to herbicides “CLEARFIELD® Corn”, “CLEARFIELD® Canola”, “CLEARFIELD® Rice”, “CLEARFIELD® Lentils”, “CLEARFIELD® Sunlowers” (BASF) with tolerance to the imidazolinone herbicides.

Furthermore, plants are also covered that are by the use of recombinant DNA techniques capable to synthesize one or more insecticidal proteins, especially those known from the bacterial genus Bacillus, particularly from Bacillus thuringiensis, such as δ-endotoxins, e.g. CryIA(b), CryIA(c), CryIF, CryIF(a2), CryIIA(b), CryIIIA, CryIIIB(b1) or Cry9c; vegetative insecticidal proteins (VIP), e.g. VIP1, VIP2, VIP3 or VIP3A; insecticidal proteins of bacteria colonizing nematodes, e.g. Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, e.g. WO 02/015701). Further examples of such toxins or genetically modified plants capable of synthesizing such toxins are disclosed, e.g., in EP-A 374753, WO 93/007278, WO 95/34656, EP-A 427529, EP-A 451878, WO 03/18810 and WO 03/52073. The methods for producing such genetically modified plants are generally known to the person skilled in the art and are described, e.g. in the publications mentioned above.

These insecticidal proteins contained in the genetically modified plants impart to the plants producing these proteins tolerance to harmful pests from all taxonomic groups of athropods, especially to beetles (Coeloptera), two-winged insects (Diptera), and moths (Lepidoptera) and to nematodes (Nematoda). Genetically modified plants capable to synthesize one or more insecticidal proteins are, e.g. described in the publications mentioned above, and some of which are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); NewLeaf® (potato cultivars producing the Cry3A toxin); BtXtra®, NatureGard®, KnockOut®, BiteGard®, Protecta®, Bt11 (e.g. Agrisure® CB) and Bt176 from Syngenta Seeds SAS, France, (corn cultivars producing the Cry1Ab toxin and PAT enyzme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC531 from Monsanto Europe S.A., Belgium (cotton cultivars producing a modified version of the Cry1Ac toxin) and 1507 from Pioneer Overseas Corporation, Belgium (corn cultivars producing the CryIF toxin and PAT enzyme).

Furthermore, plants are also covered that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, e.g. EP-A392225), plant disease resistance genes (e.g. potato cultivars, which express resistance genes acting against Phytophthora infestans derived from the mexican wild potato Solanum bulbocastanum) or T4-lysozym (e.g. potato cultivars capable of synthesizing these proteins with increased resistance against bacteria such as Erwinia amylvora). The methods for producing such genetically modified plants are generally known to the person skilled in the art and are described, e.g. in the publications mentioned above.

Furthermore, plants are also covered that are by the use of recombinant DNA techniques capable to synthesize one or more proteins to increase the productivity (e.g. bio mass production, grain yield, starch content, oil content or protein content), tolerance to drought, salinity or other growth-limiting environmental factors or tolerance to pests and fungal, bacterial or viral pathogens of those plants.

Furthermore, plants are also covered that contain by the use of recombinant DNA techniques a modified amount of substances of content or new substances of content, specifically to improve human or animal nutrition, e.g. oil crops that produce healthpromoting long-chain omega-3 fatty acids or unsaturated omega-9 fatty acids (e.g. Nexera® rape, DOW Agro Sciences, Canada).

Furthermore, plants are also covered that contain by the use of recombinant DNA techniques a modified amount of substances of content or new substances of content, specifically to improve raw material production, e.g. potatoes that produce increased amounts of amylopectin (e.g. Amflora® potato, BASF SE, Germany).

Particularly preferred modified plants suitable to be used in the methods of the present invention are those, which are rendered tolerant to herbicides, in particular tolerant to imidazolinone herbicides, most preferably those imidazolinone resistant plants set forth above.

For use according to the present invention, the inventive mixtures can be converted into the customary formulations, for example solutions, emulsions, suspensions, dusts, powders, pastes and granules. The use form depends on the particular intended purpose; in each case, it should ensure a fine and even distribution of the mixtures according to the present invention. The formulations are prepared in a known manner (cf. U.S. Pat. No. 3,060,084, EP-A 707 445 (for liquid concentrates), Browning: “Agglomeration”, Chemical Engineering, Dec. 4, 1967, 147-48, Perry's Chemical Engineer's Handbook, 4th Ed., McGraw-Hill, New York, 1963, S. 8-57 and ff. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman: Weed Control as a Science (J. Wiley & Sons, New York, 1961), Hance et al.: Weed Control Handbook (8th Ed., Blackwell Scientific, Oxford, 1989) and Mollet, H. and Grubemann, A.: Formulation Technology (Wiley VCH Verlag, Weinheim, 2001).

The agrochemical formulations may also comprise auxiliaries which are customary in agrochemical formulations. The auxiliaries used depend on the particular application form and active substance, respectively. Examples for suitable auxiliaries are solvents, solid carriers, dispersants or emulsifiers (such as further solubilizers, protective colloids, surfactants and adhesion agents), organic and anorganic thickeners, bactericides, anti-freezing agents, anti-foaming agents, if appropriate colorants and tackifiers or binders (e.g. for seed treatment formulations).

Suitable solvents are water, organic solvents such as mineral oil fractions of medium to high boiling point, such as kerosene or diesel oil, furthermore coal tar oils and oils of vegetable or animal origin, aliphatic, cyclic and aromatic hydrocarbons, e.g. toluene, xylene, paraffin, tetrahydronaphthalene, alkylated naphthalenes or their derivatives, alcohols such as methanol, ethanol, propanol, butanol and cyclohexanol, glycols, ketones such as cyclohexanone and gamma-butyrolactone, fatty acid dimethylamides, fatty acids and fatty acid esters and strongly polar solvents, e.g. amines such as Nmethylpyrrolidone.

Solid carriers are mineral earths such as silicates, silica gels, talc, kaolins, limestone, lime, chalk, bole, loess, clays, dolomite, diatomaceous earth, calcium sulfate, magnesium sulfate, magnesium oxide, ground synthetic materials, fertilizers, such as, e.g., ammonium sulfate, ammonium phosphate, ammonium nitrate, ureas, and products of vegetable origin, such as cereal meal, tree bark meal, wood meal and nutshell meal, cellulose powders and other solid carriers.

Suitable surfactants (adjuvants, wetters, tackifiers, dispersants or emulsifiers) are alkali metal, alkaline earth metal and ammonium salts of aromatic sulfonic acids, such as ligninsoulfonic acid (Borresperse® types, Borregard, Norway) phenolsulfonic acid, naphthalenesulfonic acid (Morwet® types, Akzo Nobel, U.S.A.), dibutylnaphthalenesulfonic acid (Nekal® types, BASF, Germany), and fatty acids, alkylsulfonates, alkylarylsulfonates, alkyl sulfates, laurylether sulfates, fatty alcohol sulfates, and sulfated hexa-, hepta- and octadecanolates, sulfated fatty alcohol glycol ethers, furthermore condensates of naphthalene or of naphthalenesulfonic acid with phenol and formaldehyde, polyoxy-ethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and proteins, denatured proteins, polysaccharides (e.g. methylcellulose), hydrophobically modified starches, polyvinyl alcohols (Mowiol® types, Clariant, Switzerland), polycarboxylates (Sokolan® types, BASF, Germany), polyalkoxylates, polyvinylamines (Lupasol® types, BASF, Germany), polyvinylpyrrolidone and the copolymers thereof.

Examples for thickeners (i.e. compounds that impart a modified flowability to formulations, i.e. high viscosity under static conditions and low viscosity during agitation) are polysaccharides and organic and anorganic clays such as Xanthan gum (Kelzan®, CP Kelco, U.S.A.), Rhodopol® 23 (Rhodia, France), Veegum® (R.T. Vanderbilt, U.S.A.) or Attaclay® (Engelhard Corp., NJ, USA).

Bactericides may be added for preservation and stabilization of the formulation. Examples for suitable bactericides are those based on dichlorophene and benzylalcohol hemi formal (Proxel® from ICI or Acticide® RS from Thor Chemie and Kathon® MK from Rohm & Haas) and isothiazolinone derivatives such as alkylisothiazolinones and benzisothiazolinones (Acticide® MBS from Thor Chemie).

Examples for suitable anti-freezing agents are ethylene glycol, propylene glycol, urea and glycerin.

Examples for anti-foaming agents are silicone emulsions (such as e.g. Silikon® SRE, Wacker, Germany or Rhodorsil®, Rhodia, France), long chain alcohols, fatty acids, salts of fatty acids, fluoroorganic compounds and mixtures thereof.

Suitable colorants are pigments of low water solubility and water-soluble dyes. Examples to be mentioned and the designations rhodamin B, C. I. pigment red 112, C. I. solvent red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples for tackifiers or binders are polyvinylpyrrolidons, polyvinylacetates, polyvinyl alcohols and cellulose ethers (Tylose®, Shin-Etsu, Japan).

Powders, materials for spreading and dusts can be prepared by mixing or concomitantly grinding the compounds (I) and/or (II) and/or (III) and, if appropriate, further active substances, with at least one solid carrier.

Granules, e.g. coated granules, impregnated granules and homogeneous granules, can be prepared by binding the active substances to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, e.g., ammonium sulfate, ammonium phosphate, ammonium nitrate, ureas, and products of vegetable origin, such as cereal meal, tree bark meal, wood meal and nutshell meal, cellulose powders and other solid carriers.

Examples for formulation types are:
1. Composition Types for Dilution with Water
i) Water-soluble concentrates (SL, LS)

10 parts by weight of compounds of the inventive mixtures are dissolved in 90 parts by weight of water or in a water-soluble solvent. As an alternative, wetting agents or other auxiliaries are added. The active substance dissolves upon dilution with water. In this way, a formulation having a content of 10% by weight of active substance is obtained.

ii) Dispersible concentrates (DC)

20 parts by weight of compounds of the inventive mixtures are dissolved in 70 parts by weight of cyclohexanone with addition of 10 parts by weight of a dispersant, e.g. polyvinylpyrrolidone. Dilution with water gives a dispersion. The active substance content is 20% by weight.

iii) Emulsifiable concentrates (EC)

15 parts by weight of compounds of the inventive mixtures are dissolved in 75 parts by weight of xylene with addition of calcium dodecylbenzenesulfonate and castor oil ethoxylate (in each case 5 parts by weight). Dilution with water gives an emulsion. The composition has an active substance content of 15% by weight.

### iv) Emulsions (EW, EO, ES)

25 parts by weight of compounds of the inventive mixtures are dissolved in 35 parts by weight of xylene with addition of calcium dodecylbenzenesulfonate and castor oil ethoxylate (in each case 5 parts by weight). This mixture is introduced into 30 parts by weight of water by means of an emulsifying machine (Ultraturrax) and made into a homogeneous emulsion. Dilution with water gives an emulsion. The composition has an active substance content of 25% by weight.

### v) Suspensions (SC, OD, FS)

In an agitated ball mill, 20 parts by weight of compounds of the inventive mixtures are comminuted with addition of 10 parts by weight of dispersants and wetting agents and 70 parts by weight of water or an organic solvent to give a fine active substance suspension. Dilution with water gives a stable suspension of the active substance. The active substance content in the composition is 20% by weight.

vi) Water-dispersible granules and water-soluble granules (WG, SG) 50 parts by weight of compounds of the inventive mixtures are ground finely with addition of 50 parts by weight of dispersants and wetting agents and prepared as waterdispersible or water-soluble granules by means of technical appliances (e.g. extrusion, spray tower, fluidized bed). Dilution with water gives a stable dispersion or solution of the active substance. The composition has an active substance content of 50% by weight.
vii) Water-dispersible powders and water-soluble powders (WP, SP, SS, WS) 75 parts by weight of compounds of the inventive mixtures are ground in a rotor-stator mill with addition of 25 parts by weight of dispersants, wetting agents and silica gel.

Dilution with water gives a stable dispersion or solution of the active substance. The active substance content of the composition is 75% by weight.

viii) Gel (GF)

In an agitated ball mill, 20 parts by weight of compounds of the inventive mixtures are comminuted with addition of 10 parts by weight of dispersants, 1 part by weight of a gelling agent wetters and 70 parts by weight of water or of an organic solvent to give a fine suspension of the active substance. Dilution with water gives a stable suspension of the active substance, whereby a composition with 20% (w/w) of active substance is obtained.

### 2. Composition Types to be Applied Undiluted

ix) Dustable powders (DP, DS)

5 parts by weight of compounds of the inventive mixtures are ground finely and mixed intimately with 95 parts by weight of finely divided kaolin. This gives a dustable composition having an active substance content of 5% by weight.

### x) Granules (GR, FG, GG, MG)

0.5 parts by weight of compounds of the inventive mixtures is ground finely and associated with 99.5 parts by weight of carriers. Current methods are extrusion, spray-drying or the fluidized bed. This gives granules to be applied undiluted having an active substance content of 0.5% by weight.

xi) ULV solutions (UL)

10 parts by weight of compounds of the inventive mixtures are dissolved in 90 parts by weight of an organic solvent, e.g. xylene. This gives a composition to be applied undiluted having an active substance content of 10% by weight.

The agrochemical formulations generally comprise between 0.01 and 95%, preferably between 0.1 and 90%, most preferably between 0.5 and 90%, by weight of active substances. The compounds of the inventive mixtures are employed in a purity of from 90% to 100%, preferably from 95% to 100% (according to NMR spectrum).

The compounds of the inventive mixtures can be used as such or in the form of their compositions, e.g. in the form of directly sprayable solutions, powders, suspensions, dispersions, emulsions, oil dispersions, pastes, dustable products, materials for spreading, or granules, by means of spraying, atomizing, dusting, spreading, brushing, immersing or pouring. The application forms depend entirely on the intended purposes; it is intended to ensure in each case the finest possible distribution of the compounds present in the inventive mixtures.

Aqueous application forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active substance concentrations in the ready-to-use preparations can be varied within relatively wide ranges. In general, they are from 0.0001 to 10%, preferably from 0.001 to 1% by weight of compounds of the inventive mixtures.

The compounds of the inventive mixtures may also be used successfully in the ultralow-volume process (ULV), it being possible to apply compositions comprising over 95% by weight of active substance, or even to apply the active substance without additives.

Various types of oils, wetters, adjuvants, herbicides, fungicides, other pesticides, or bactericides may be added to the active compounds, if appropriate not until immediately prior to use (tank mix). These agents can be admixed with the compounds of the inventive mixtures in a weight ratio of 1:100 to 100:1, preferably 1:10 to 10:1.

Compositions of this invention may also contain fertilizers such as ammonium nitrate, urea, potash, and superphosphate, phytotoxicants and plant growth regulators and safeners. These may be used sequentially or in combination with the above-described compositions, if appropriate also added only immediately prior to use (tank mix). For example, the plant(s) may be sprayed with a composition of this invention either before or after being treated with the fertilizers.

The compounds contained in the mixtures as defined above can be applied simultaneously, that is jointly or separately, or in succession, the sequence, in the case of separate application, generally not having any effect on the result of the control measures.

According to this invention, applying the compound (I) and compound (II) and, in the case of ternary mixtures, compound (III) is to be understood to denote, that at least the compound (I) and compound (II) and, in the case of ternary mixtures, compound (III) occur simultaneously at the site of action (i.e. plant, plant propagation material (preferably seed), soil, area, material or environment in which a plant is growing or may grow) in a effective amount.

This can be obtained by applying the compound (I) and compound (II) and, in the case of ternary mixtures, compound (III) simultaneously, either jointly (e.g. as tank-mix) or seperately, or in succession, wherein the time interval between the individual applications is selected to ensure that the active substance applied first still occurs at the site of action in a sufficient amount at the time of application of the further active substance(s). The order of application is not essential for working of the present invention.

In the inventive mixtures, the weight ratio of the compounds generally depends from the properties of the compounds of the inventive mixtures.

The compounds of the inventive mixtures can be used individually or already partially or completely mixed with one another to prepare the composition according to the invention. It is also possible for them to be packaged and used further as combination composition such as a kit of parts.

In one embodiment of the invention, the kits may include one or more, including all, components that may be used to prepare a subject agrochemical composition. E.g., kits may include the compound (I) and compound (II) and, in the case of ternary mixtures, compound (III) and/or an adjuvant component and/or a further pesticidal compound (e.g. insecticide, fungicide or herbicide) and/or a growth regulator component). One or more of the components may already be combined together or pre-formulated. In those embodiments where more than two components are provided in a kit, the components may already be combined together and as such are packaged in a single container such as a vial, bottle, can, pouch, bag or canister. In other embodiments, two or more components of a kit may be packaged separately, i.e., not pre-formulated. As such, kits may include one or more separate containers such as vials, cans, bottles, pouches, bags or canisters, each container containing a separate component for an agrochemical composition. In both forms, a component of the kit may be applied separately from or together with the further components or as a component of a combination composition according to the invention for preparing the composition according to the invention.

The user applies the composition according to the invention usually from a predosage device, a knapsack sprayer, a spray tank or a spray plane. Here, the agrochemical composition is made up with water and/or buffer to the desired application concentration, it being possible, if appropriate, to add further auxiliaries, and the ready-to-use spray liquid or the agrochemical composition according to the invention is thus obtained. Usually, 50 to 500 liters of the ready-to-use spray liquor are applied per hectare of agricultural useful area, preferably 50 to 400 liters.

According to one embodiment, individual compounds of the inventive mixtures formulated as composition (or formulation) such as parts of a kit or parts of the inventive mixture may be mixed by the user himself in a spray tank and further auxiliaries may be added, if appropriate (tank mix).

In a further embodiment, either individual compounds of the inventive mixtures formulated as composition or partially premixed components, e.g. components comprising the compound (I) and compound (II) and, in the case of ternary mixtures, compound (III) may be mixed by the user in a spray tank and further auxiliaries and additives may be added, if appropriate (tank mix).

In a further embodiment, either individual components of the composition according to the invention or partially premixed components, e.g. components comprising the compound (I) and compound (II) and, in the case of ternary mixtures, compound (III), can be applied jointly (e.g. after tankmix) or consecutively.

The term “effective amount” denotes an amount of the inventive mixtures, which is sufficient for achieving the synergistic plant health effects, in particular the yield effects as defined herein. More exemplary information about amounts, ways of application and suitable ratios to be used is given below. Anyway, the skilled artisan is well aware of the fact that such an amount can vary in a broad range and is dependent on various factors, e.g. the treated cultivated plant or material and the climatic conditions.

When preparing the mixtures, it is preferred to employ the pure active compounds, to which further active compounds against pests, such as insecticides, herbicides, fungicides or else herbicidal or growth-regulating active compounds or fertilizers can be added as further active components according to need.

Principally, the application rates of the inventive mixtures are from 0.3 g/ha to 2000 g/ha, preferably 5 g/ha to 2000 g/ha, more preferably from 20 to 900 g/ha, even more preferably from 20 to 750 g/ha in particular from 35 to 100 g/ha.

Seed treatment can be made into the seedbox before planting into the field.

For seed treatment purposes, the weight ration in the binary and ternary mixtures of the present invention generally depends from the properties of the compounds of the inventive mixtures.

Compositions, which are especially useful for seed treatment are e.g.:

A Soluble concentrates (SL, LS)

### D Emulsions (EW, EO, ES)

### E Suspensions (SC, OD, FS)

F Water-dispersible granules and water-soluble granules (WG, SG)
G Water-dispersible powders and water-soluble powders (WP, SP, WS)

### H Gel-formulations (GF)

I Dustable powders (DP, DS)

These compositions can be applied to plant propagation materials, particularly seeds, diluted or undiluted. The compositions in question give, after two-to-tenfold dilution, active substance concentrations of from 0.01 to 60% by weight, preferably from 0.1 to 40% by weight, in the ready-to-use preparations. Application can be carried out before or during sowing. Methods for applying or treating agrochemical compounds and compositions thereof, respectively, on to plant propagation material, especially seeds, are known in the art, and include dressing, coating, pelleting, dusting and soaking application methods of the propagation material (and also in-furrow treatment). In a preferred embodiment, the compounds or the compositions thereof, respectively, are applied on to the plant propagation material by a method such that germination is not induced, e.g. by seed dressing, pelleting, coating and dusting.

In the treatment of plant propagation material (preferably seed), the application rates of the inventive mixture are generally for the formulated product (which usually comprises from 10 to 750 g/l of the active(s)).

The invention also relates to the propagation products of plants, and especially the seed comprising, that is, coated with and/or containing, a mixture as defined above or a composition containing the mixture of two or more active ingredients or a mixture of two or more compositions each providing one of the active ingredients. The plant propagation material (preferably seed) comprises the inventive mixtures in an amount of from 0.01 g to 3 kg per 100 kg of plant propagation material (preferably seed).

The separate or joint application of the compounds of the inventive mixtures is carried out by spraying or dusting the seeds, the seedlings, the plants or the soils before or after sowing of the plants or before or after emergence of the plants.

The following examples are intended to illustrate the invention, but without imposing any limitation.

### EXAMPLES

### Example 1

Imidazolinone tolerant soybeans were grown in 2009 at the BASF experimental station in Campinas, San Antonio de Posse, Sao Paulo, Brazil, in a pot experiment. The soybean plants were planted with 5 plants per pot in pots with a diameter of 25 cm. The pots were sprayed when soybeans showed fully developed trifoliolates on nodes 3 or 4, respectively.

The active ingredients were used as commercially available formulations. For pyraclostrobin (F500®) the product COMET® was applied. Imazapyr was applied as ARSENAL FORESTAL® and the mixture of imazapic and imazapyr was used as the product SOYVANCE®. The surfactant ASSIST® was added to the herbicide spray solution with a concentration of 1% (v/v). The formulations were used in the dose rates given in the tables below. COMET® and ARSENAL FORRESTAL® and COMET® and SOYVANCE® were tank mixed to get the mixture of pyraclostrobin and imazapyr and the mixture of pyraclostrobin and imazapic plus imazapyr.

Chlorophyll content was measured by using a Konica-Minolta SPAD 502 chlorophyll-meter. Stomatal conductance gs (mol m⁻²s⁻¹) was measured using an infrared gas analyzer (Licor LI 6400). Measurements for both parameters were done 1, 7 and 14 days after application (DAA). The efficacy for both parameters was calculated as % increase of chlorophyll content (SPAD values) or stomatal conductance (gs) in the treatments compared to the untreated control:

E=a/b−1·100
a corresponds to the SPAD or stomatal conductance value of the treated plants and
b corresponds to the SPAD or stomatal conductance value of the untreated (control) plants

An efficacy of 0 means the level of the chlorophyll content and stomatal conductance of the treated plants corresponds to that of the untreated control plants; an efficacy of 100 means the treated plants showed an increase in chlorophyll content and stomatal conductance of 100% compared to the untreated control.

The expected efficacies (E) of the combinations of the active compounds were estimated using Colby's formula (Colby, S. R., Calculating synergistic and antagonistic responses of herbicide combinations, Weeds, 15, pp. 20-22, 1967) and compared with the observed efficacies (OE).

E=x+y−x·y/100 Colby's formula
E expected efficacy, expressed in % of the untreated control, when using the mixture of the active compounds A and B at the concentrations a and b
x efficacy, expressed in % of the untreated control, when using the active ingredient A at the concentration a
y efficacy, expressed in % of the untreated control, when using the active ingredient B at the concentration b

TABLE 3
Chlorophyll Content (SPAD); 1 DAA (day after application)

| | | | | | | OE | E | S |
|---|---|---|---|---|---|---|---|---|
| Product | PR | FC | FT | AT | SPAD | (%) | (%) | (%) |
| 1. Control | | | | | 26.9 | | | |
| 2. Pyra- | 0.6 L/ha | 250 g/L | EC | 14 | 27.6 | 2.6 | | |
| clostrobin | | | | | | | | |
| 3. Imaza- | 0.3 L/ha | 480 g/L | SL | 14 | 26.5 | −1.5 | | |
| pyr | | | | | | | | |
| 4. Pyra- | 0.6 L/ha | 250 g/L | FS | 14 | 33.6 | 24.8 | 1.2 | 23.6 |
| clostro- | 0.3 L/ha | 480 g/L | SL | 14 | | | | |
| bin + | | | | | | | | |
| Imazapyr | | | | | | | | |

In Table 3, the following abbreviations are used:
PR = product rate;
FC = formulation concentration;
FT = formulation type;
AT = application time point (BBCH);
SPAD = chlorophyll content;
OE = observed efficacy (%);
E = expected efficacy;
S = synergism (%).

The results shown in table 3 clearly demonstrate that the observed efficacy (OE) exceeds by far the expected efficacy (E) which was calculated using Colby's formula as described above. Accordingly, the use of the mixture according to the invention comprising imazapyr as compound (I) and pyraclostrobin as compound (II) synergistically increases the plant health which gets manifest by the synergistic increase of the chlorophyll content by more than 23%. It is well known that chlorophyll content correlates with photosynthesis rate and yield. The higher the chlorophyll content, the higher the yield.

TABLE 4
Stomatal Conductance (gs); 1 DAA (day after application)

| Product | PR | | FC | FT | AT | SC | OE (%) | E (%) | S (%) |
|---|---|---|---|---|---|---|---|---|---|
| 1. Control | | | | | | 0.392 | | | |
| 2. Pyraclostrobin | 0.3 | L/ha | 250 g/L | EC | 14 | 0.421 | 7.4 | | |
| 3. Imazapyr | 0.075 | L/ha | 480 g/L | SL | 14 | 0.380 | −3.1 | | |
| 4. Pyraclostrobin + | 0.3 | L/ha | 250 g/L | FS | 14 | 0.526 | 34.2 | 4.56 | 29.6 |
| Imazapyr | 0.075 | L/ha | 480 g/L | SL | 14 | | | | |

In Table 4, the following abbreviations are used:
PR = product rate;
FC = formulation concentration;
FT = formulation type;
AT = application time point (BBCH);
SC = Stomatal Conductance (gs) in (mol m⁻²s⁻¹);
OE = observed efficacy (%);
E = expected efficacy;
S = synergism (%).

The results shown in table 4 clearly demonstrate that the observed efficacy (OE) exceeds by far the expected efficacy (E) which was calculated using Colby's formula as described above. Accordingly, the use of the binary mixture according to the invention comprising imazapyr as compound (I) and pyraclostrobin as compound (II) synergistically increases the plant health which gets manifest by the synergistic increase of the stomatal conductance by almost 30%. Higher stomatal conductance increases CO₂ diffusion into the leaf and favors higher photosynthetic rates. Higher photosynthetic rates in turn favor a higher biomass and higher crop yields.

TABLE 5
Stomatal Conductance (gs); 7 DAA (days after application)

| | | | | | | | | OE | E | S |
|---|---|---|---|---|---|---|---|---|---|---|
| Product | PR | | FC | | FT | AT | SC | (%) | (%) | (%) |
| 1. Control | | | | | | | 0.254 | | | |
| 2. Pyraclostrobin | 0.3 | L/ha | 250 | g/L | EC | 14 | 0.169 | −33.5 | | |
| 3. Imazapyr + | 0.05 | kg/ha | 700 | g/kg | WG | 14 | 0.454 | 78.7 | | |
| Imazapic | | | | | | | | | | |
| 4. Pyraclostrobin + | 0.3 | L/ha | 250 | g/L | FS | 14 | 0.582 | 129.1 | 71.6 | 57.5 |
| Imazapyr + Ima- | 0.05 | kg/ha | 700 | g/kg | WG | 14 | | | | |
| zapic | | | | | | | | | | |

In Table 5, the following abbreviations are used:
PR = product rate;
FC = formulation concentration;
FT = formulation type;
AT = application time point (BBCH);
SC = Stomatal Conductance (gs) in (mol m⁻²s⁻¹);
OE = observed efficacy (%);
E = expected efficacy;
S = synergism (%).

The results shown in table 5 clearly demonstrate that the observed efficacy (OE) exceeds by far the expected efficacy (E) which was calculated using Colby's formula as described above. Accordingly, the use of the ternary mixture according to the invention comprising imazapyr as compound (I), pyraclostrobin as compound (II) and imazapic as compound (III) synergistically increases the plant health which gets manifest by the synergistic increase of the stomatal conductance by almost 60%. Higher stomatal conductance increases CO₂ diffusion into the leaf and favors higher photosynthetic rates. Higher photosynthetic rates in turn favor a higher biomass and higher crop yields.

As can be seen in the data provided above, the binary and ternary mixtures according to the invention synergistically improve the health of a plant.

1-15. (canceled)

16. A mixture for increasing the health of a plant comprising, as active ingredients:
i) an imidazolinone herbicide as compound (I) selected from the group consisting of imazamethabenz-methyl, imazamox, imazapic, imazapyr, imazaquin and imazethapyr; and
ii) a fungicidal compound (II) of the formula 1 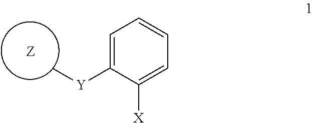
wherein
X is —C(═NOCH₃)—CONHCH₃, —C(═NOCH₃)—COOCH₃, —C(═CHOCH₃)—COOCH₃, —N(OCH₃)—COOCH₃ or —C(═NOCH₃)—R, where
R is 4H-[1,5,2]dioxazin-3-yl;
Y is —O—, —OCH₂—, —C(CH₃)═NOCH₂— or —CH═CH—C(CH₃)═NOCH₂—; and
Z is an aromatic ring system being unsubstituted or substituted, selected from the group consisting of phenyl, 2-methylphenyl, 3-trifluoromethylphenyl, 2,5-dimethylphenyl, 4-chlorophenyl, 2,6-dichlorophenyl, 4-chlorphenyl-1H-pyrazol-3-yl, 6-(2-cyanophenoxy)pyrimidin-4-yl, 6-(2-chlorophenoxy)-5-fluoro-pyrimidin-4-yl, 6-trifluoromethyl-pyridin-2-yl, 3-butyl-4-methyl-2-oxo-2H-chromen-7-yl and 3,4-dimethyl-2-oxo-2H-chromen-7-yl;
in synergistically effective amounts.

17. The mixture of claim 16, comprising as active ingredients:
i) an imidazolinone herbicide as compound (I) selected from the group consisting of imazamethabenz-methyl, imazamox, imazapic, imazapyr, imazaquin and imazethapyr; and
ii) a strobilurine fungicide as compound (II) selected from the group consisting of azoxystrobin, coumoxystrobin, coumethoxystrobin, dimoxystrobin, enestroburin, fluoxastrobin, kresoxim-methyl, metominostrobin, picoxystrobin, pyraclostrobin, pyrametostrobin, pyraoxystrobin, trifloxystrobin, 2-(2-(3-(2,6-di-chlorophenyl)-1-methyl-allylidene-aminooxy-methyl)-phenyl)-2-methoxyimino-N-methyl-acetamide and 2-[2-(2,5-dimethyl-phenoxymethyl)-phenyl]-3-methoxy-acrylic acid methyl ester;
in synergistically effective amounts.

18. The mixture of claim 16, wherein compound (I) is selected from the group consisting of imazamox, imazethapyr, imazapic and imazapyr.

19. The mixture of claim 18, wherein the fungicidal compound (II) is azoxystrobin, trifloxystrobin, picoxystrobin or pyraclostrobin.

20. The mixture of claim 18, wherein the fungicidal compound (II) is pyraclostrobin.

21. The mixture of claim 16, additionally comprising a second imidazolinone herbicide as compound (III) selected from the group consisting of imazamethabenz-methyl, imazamox, imazapic, imazapyr, imazaquin and imazethapyr.

22. The mixture of claim 21, wherein compound (I) is imazapyr, compound (II) is pyraclostrobin, and compound (III) is imazethapyr, imazapic or imazamox.

23. The mixture of claim 21, wherein compound (I) is imazamox, compound (II) is pyraclostrobin, and compound (III) is imazethapyr or imazapic.

24. The mixture of claim 21, wherein compound (I) is imazapic, compound (II) is pyraclostrobin, and compound (III) is imazethapyr.

25. A pesticidal composition comprising a liquid or solid carrier and the mixture of claim 16.

26. A method of increasing the health of a plant that is tolerant to imidazolinone herbicides comprising applying a synergistically effective amount of the mixture of claim 16 to the plant, plant propagule or locus where the plant is planted.

27. The method of claim 26, wherein the chlorophyll content of the plant is increased.

28. The method of claim 26, wherein the plant is selected from the group consisting of soybean, wheat, sunflower, canola, oilseed rape, corn, cotton, sugar cane, juncea, peas, lentils and alfalfa.

29. The method of claim 26, wherein the plant is soybean.

30. The method of claim 28, wherein the mixture additionally comprises a second imidazolinone herbicide as compound (III) selected from the group consisting of imazamethabenz-methyl, imazamox, imazapic, imazapyr, imazaquin and imazethapyr.

31. The method of claim 30, wherein compound (I) is imazapyr, compound (II) is pyraclostrobin, and compound (III) is imazethapyr, imazapic or imazamox.

32. The method of claim 30, wherein compound (I) is imazamox, compound (II) is pyraclostrobin, and compound (III) is imazethapyr or imazapic.

33. A method of increasing the yield of a plant that is tolerant to imidazolinone herbicides comprising applying a synergistically effective amount of the mixture of claim 16 to the plant, plant propagule or locus where the plant is planted.

34. The method of claim 33, wherein the plant is selected from the group consisting of soybean, wheat, sunflower, canola, oilseed rape, corn, cotton, sugar cane, juncea, peas, lentils and alfalfa.

35. The method of claim 34, wherein the plant is soybean.
